(19) United States
(12) Patent Application Publication
(10) Pub. No.: US 2024/0429651 A1
(43) Pub. Date: Dec. 26, 2024

(54) BREAKAWAY ELECTRICAL CONNECTORS

(71) Applicant: Hubbell Incorporated, Shelton, CT (US)

(72) Inventors: William Henry Dietz, Shelton, CT (US); Thomas Lewis Scanzillo, Shelton, CT (US); Roy Itzler, Shelton, CT (US); Robert Daniel Schazinski, Shelton, CT (US)

(73) Assignee: Hubbell Incorporated, Shelton, CT (US)

(21) Appl. No.: 18/749,738

(22) Filed: Jun. 21, 2024

Related U.S. Application Data
(60) Provisional application No. 63/509,364, filed on Jun. 21, 2023.
(60) Provisional application No. 63/548,688, filed on Feb. 1, 2024.
(60) Provisional application No. 63/555,034, filed on Feb. 18, 2024.

(51) Int. Cl. H01R 13/62; H01R 13/52; H01R 24/86; H01R 107/00

(52) U.S. Cl. CPC H01R 13/6205; H01R 13/5219; H01R 24/86; H01R 2107/00

(57) ABSTRACT

A breakaway electrical connector is provided. The connector includes a first side that is connectable to a first conductor and a second side that is connectable to a second conductor. The first side has a magnetic assembly and a first plurality of contacts, while the second side has a strike plate and a second plurality of contacts. The magnetic assembly provides a magnetic connection force with respect to the strike plate to maintain the first and second sides in a connected state with the first and second plurality of contacts electrically coupled to one another.

### CROSS REFERENCE TO RELATED APPLICATIONS

This application claims benefit of U.S. Provisional Application 63/509,364 filed Jun. 21, 2023, U.S. Provisional Application 63/548,688 filed Feb. 1, 2024, and U.S. Provisional Application 63/555,034 filed Feb. 18, 2024, the entire contents of all of which are incorporated herein by reference.

### BACKGROUND

### 1. Field of the Invention

The present disclosure is related to electrical connectors. More particularly, the present disclosure is related to breakaway electrical connectors.

### 2. Description of Related Art

It is becoming common for vehicles such as, but not limited to tractor trailers, trains, campers, load trailers, and others, to have a temporary need for a supply of electrical power provided by something other than the engine of the vehicle that is supplying the driving power.

For example, refrigerated tractor trailers often have a need to power the refrigerators to maintain the cargo in a refrigerated state, while the truck is stopped as can occur at loading/unloading locations or when stationary during a driving break. In another example, camping trailers often have a need to power one or more consumer devices (e.g., lights, HVAC, etc.) when the camping trailer is in a stationary location.

To maintain greenhouse gas emissions at a minimum, it is also common for such locations to have prohibitions against idling-namely require the user to stop the vehicle engine to prevent un-necessary use of fuels, while mitigating the amount of associated exhaust gases.

Many of these locations provide a power source, which allows the trailer to connect while stopped. These power sources typically involve an outlet or other plug for temporary connection by the trailer. These connections can be damaged in the event of an accidental drive off, namely when the trailer is moved without disconnection from the outlet or plug.

It is also becoming common for electrical commercial equipment to be installed such that it can be moved for cleaning activities such as occurs in food service and various manufacturing environments. The use location provides a power source, which allows the commercial equipment to be connected while in use. These power sources typically involve an outlet or other plug for temporary connection by the commercial equipment. These connections can be damaged during movement of the commercial equipment without properly disconnecting the outlet or plug.

Furthermore, in some food service applications, the power source is installed overhead using what is commonly referred to as a cord drop connection. Here, the overhead nature of such cord drop connections can make engaging and disengaging the plugs and connectors difficult for staff due to the overhead nature of cord drop connections. Simply, the forces and actions needed to make and unmake the connections can be ergonomically difficult to achieve.

Accordingly, it has been determined by the present disclosure that there is a need for breakaway electrical connectors that overcome, alleviate, and/or mitigate one or more of the aforementioned and other deleterious effects of the prior art.

Further, it has been determined by the present disclosure that the number of connectors already installed—in the trucking and food service industries—may reduce the adoption of new breakaway connectors that resolve the aforementioned issues. Accordingly, it has also been determined by the present disclosure that there is a need for retrofit assemblies that are configured to convert prior art electrical connectors into breakaway electrical connectors.

### SUMMARY

A breakaway electrical connector is provided. The connector includes a first side that is connectable to a first conductor and a second side that is connectable to a second conductor. The first side has a magnetic assembly and a first plurality of contacts, while the second side has a strike plate and a second plurality of contacts. The magnetic assembly provides a magnetic connection force with respect to the strike plate to maintain the first and second sides in a connected state with the first and second plurality of contacts electrically coupled to one another.

In some embodiments either alone or together with any one or more of the aforementioned and/or after-mentioned embodiments, the connector further includes a seal that seals the first and second sides when in the connected state. The seal is positioned radially outside of the magnetic assembly and radially outside of the first and second plurality of contacts.

In some embodiments either alone or together with any one or more of the aforementioned and/or after-mentioned embodiments, the first side is a line side and the second side is a load side.

In some embodiments either alone or together with any one or more of the aforementioned and/or after-mentioned embodiments, the line side further includes a shroud extending around the first plurality of contacts between the first plurality of contacts and the magnetic assembly. The load side further includes a recess defined around the second plurality of contacts between the second plurality of contacts and the magnetic assembly. The recess receives the shroud when the first and second plurality of contacts are in the connected state.

In some embodiments either alone or together with any one or more of the aforementioned and/or after-mentioned embodiments, the connector further includes a seal that seals the line and load sides when in the connected state, the seal being positioned radially outside of the magnetic assembly, the shroud, the recess, and the first and second plurality of contacts.

In some embodiments either alone or together with any one or more of the aforementioned and/or after-mentioned embodiments, the first side is a load side and the second side is a line side.

In some embodiments either alone or together with any one or more of the aforementioned and/or after-mentioned embodiments, the line side further includes a shroud extending around the first plurality of contacts between the first plurality of contacts and the magnetic assembly. The load side further includes a recess defined around the second plurality of contacts between the second plurality of contacts and the magnetic assembly. The recess receives the shroud when the first and second plurality of contacts are in the connected state.

In some embodiments either alone or together with any one or more of the aforementioned and/or after-mentioned embodiments, the connector further includes a seal that seals the line and load sides when in the connected state. The seal is positioned radially outside of the magnetic assembly, the shroud, the recess, and the first and second plurality of contacts.

In some embodiments either alone or together with any one or more of the aforementioned and/or after-mentioned embodiments, the shroud and the recess are electrically insulating material.

In some embodiments either alone or together with any one or more of the aforementioned and/or after-mentioned embodiments, the line and load sides are configured to that the recess receives the shroud prior to the first plurality of contacts being within an electrically communicating distance of the second plurality of contacts during movement between the connected state and a disconnected state.

In some embodiments either alone or together with any one or more of the aforementioned and/or after-mentioned embodiments, the magnetic connection force is lower than a pull-apart strength of the line side and the load side.

In some embodiments either alone or together with any one or more of the aforementioned and/or after-mentioned embodiments, the magnetic connection force is between 45 and 95 pounds.

In some embodiments either alone or together with any one or more of the aforementioned and/or after-mentioned embodiments, the magnetic connection force is between 60 and 85 pounds.

In some embodiments either alone or together with any one or more of the aforementioned and/or after-mentioned embodiments, the magnetic assembly includes a first plate, a magnet holder, a plurality of magnets in the magnet holder, and a second plate. The magnetic assembly is in the first side so that the second plate contacts the strike plate in the connected state.

In some embodiments either alone or together with any one or more of the aforementioned and/or after-mentioned embodiments, the first plate and the strike plate are identical.

In some embodiments either alone or together with any one or more of the aforementioned and/or after-mentioned embodiments, the first plate, the strike plate, and the second plate are ferrous material.

In some embodiments either alone or together with any one or more of the aforementioned and/or after-mentioned embodiments, the strike plate and the first plate are made of 410 and the second plate is made of 430 stainless steel.

In some embodiments either alone or together with any one or more of the aforementioned and/or after-mentioned embodiments, the magnet holder is made of a magnetic or non-magnetic material.

In some embodiments either alone or together with any one or more of the aforementioned and/or after-mentioned embodiments, the connector further includes a plurality of mechanical fasteners passing through the magnetic assembly and securing the magnetic assembly to the first side.

In some embodiments either alone or together with any one or more of the aforementioned and/or after-mentioned embodiments, the first plate has a first thickness dimensioned, with respect to a magnet flux of the plurality of magnets, so that the first plate is fully saturated by the magnetic flux. The second plate has a second thickness dimensioned, with respect to the magnet flux, so that the second plate is not fully saturated by the magnetic flux.

In some embodiments either alone or together with any one or more of the aforementioned and/or after-mentioned embodiments. The plurality of magnets each have a southern pole and a northern pole. The magnetic assembly has an even number of magnets arranged with adjacent magnets having the northern and southern poles in opposite directions.

In some embodiments either alone or together with any one or more of the aforementioned and/or after-mentioned embodiments, the magnet holder, and the second plate further include an alignment feature thereon that corresponds to another alignment feature in the first side.

In some embodiments either alone or together with any one or more of the aforementioned and/or after-mentioned embodiments, the magnetic assembly has a central opening configured so that the first plurality of contacts are within the central opening.

In some embodiments either alone or together with any one or more of the aforementioned and/or after-mentioned embodiments, the second plate has an inner dimension and an outer dimension that completely covers a top surface of the magnetic holder.

In some embodiments either alone or together with any one or more of the aforementioned and/or after-mentioned embodiments, the second plate has an inner dimension and an outer dimension that completely covers a top surface of the plurality of magnets.

The above-described and other features and advantages of the present disclosure will be appreciated and understood by those skilled in the art from the following detailed description, drawings, and appended claims.

### DESCRIPTION OF THE DRAWINGS

FIG. 1 is a perspective view a breakaway electrical connector according to an exemplary embodiment of the present disclosure in a connected state;

FIG. 2 is a perspective view of the breakaway electrical connector of FIG. 1 in a disconnected state illustrating a line side of the connector;

FIG. 3 is a perspective view of the breakaway electrical connector of FIG. 1 in the disconnected state illustrating a load side of the connector;

FIGS. 4A-4B are end views of the line and load sides of FIG. 1 in the disconnected state;

FIGS. 5A-5B are end views of an alternate embodiment of the line and load sides of FIG. 1 in the disconnected state;

FIG. 6 is a partial sectional view of the breakaway electrical connector of FIG. 1 in the disconnected state;

FIG. 7 is a partial sectional view of the breakaway electrical connector of FIG. 1 in the connected state;

FIG. 8A is a perspective view an alternate embodiment of the breakaway electrical connector according to an exemplary embodiment of the present disclosure in a connected state;

FIG. 8B is a side view of the breakaway electrical connector of FIG. 8A in the connected state;

FIG. 8C is a partial sectional view of the breakaway electrical connector of FIGS. 8A-8B in the connected state;

FIG. 8D is an enlarged view of the bumper of FIG. 8C;

FIG. 9 is a perspective view of the line side of FIG. 2 shown in a partially disassembled state illustrating a magnetic assembly;

FIGS. 10-12 illustrate an exemplary embodiment of a magnet holder of the magnetic assembly of FIG. 9;

FIG. 13 is a perspective view of a pull force testing configuration for testing exemplary embodiments of magnetic assemblies according to the present disclosure;

FIG. 14 illustrates pull force test results according to the present disclosure;

FIGS. 15-16 are partial sectional views of the breakaway electrical connector according to the present disclosure illustrating an exemplary embodiment of a lip seal in the disconnected and connected states;

FIG. 17 is a partial sectional view of the breakaway electrical connector according to the present disclosure illustrating an exemplary embodiment of a gasket seal in the connected state;

FIG. 18 is a partial sectional view of the breakaway electrical connector according to the present disclosure illustrating a first exemplary embodiment of an O-ring seal in the connected state;

FIG. 19 is a partial sectional view of the breakaway electrical connector according to the present disclosure illustrating another exemplary embodiment of an O-ring seal in the connected state;

FIG. 20 is a side view of a prior art pin and sleeve electrical connector in a disconnected state;

FIG. 21 is a side view of the prior art pin and sleeve electrical connector of FIG. 20 after conversion to a breakaway connector using an exemplary embodiment of a breakaway retrofit assembly according to the present disclosure;

FIG. 22 is a perspective view of components in a load side of the breakaway retrofit assembly of FIG. 21;

FIG. 23 is an exploded view of components in the load side of the breakaway retrofit assembly of FIG. 21;

FIG. 24 is a perspective view of an alternate embodiment of a retainer ring of the retrofit assembly of FIG. 21;

FIGS. 25-26 are perspective views of components in a line side of the retrofit assembly of FIG. 21;

FIG. 27 is an exploded view of components in the line side of the breakaway retrofit assembly of FIG. 21;

FIGS. 28-33 illustrate an exemplary method of installing the load side of the breakaway retrofit assembly of the present disclosure;

FIGS. 34-37 illustrate an exemplary method of installing the line side of the breakaway retrofit assembly of the present disclosure;

FIG. 38 illustrates an alternative method of installing the line side of FIGS. 34-37; and

FIG. 39 illustrates pull force test results according to the present disclosure.

### DETAILED DESCRIPTION

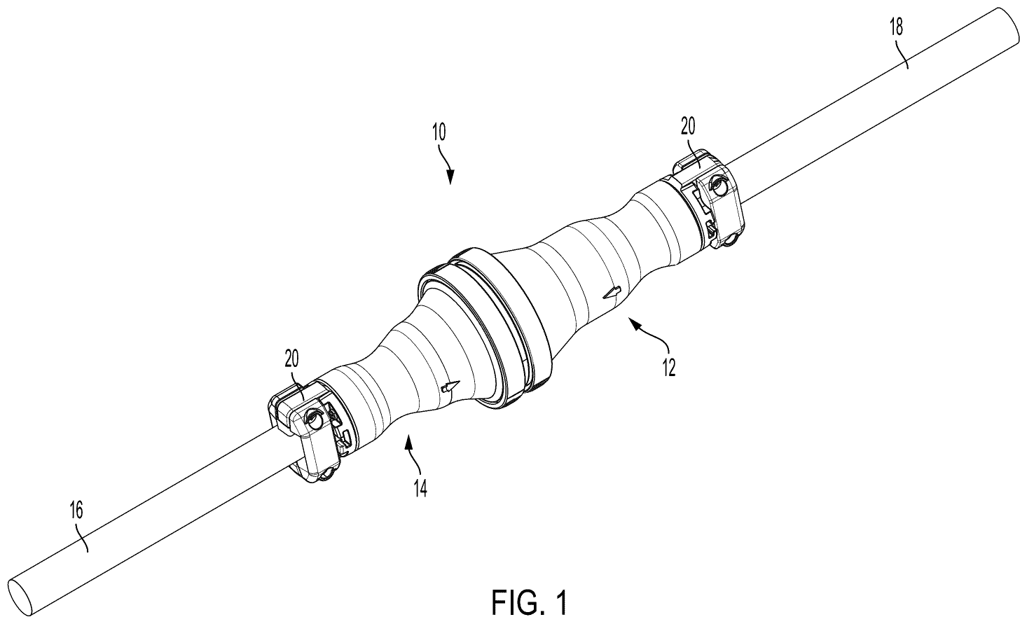

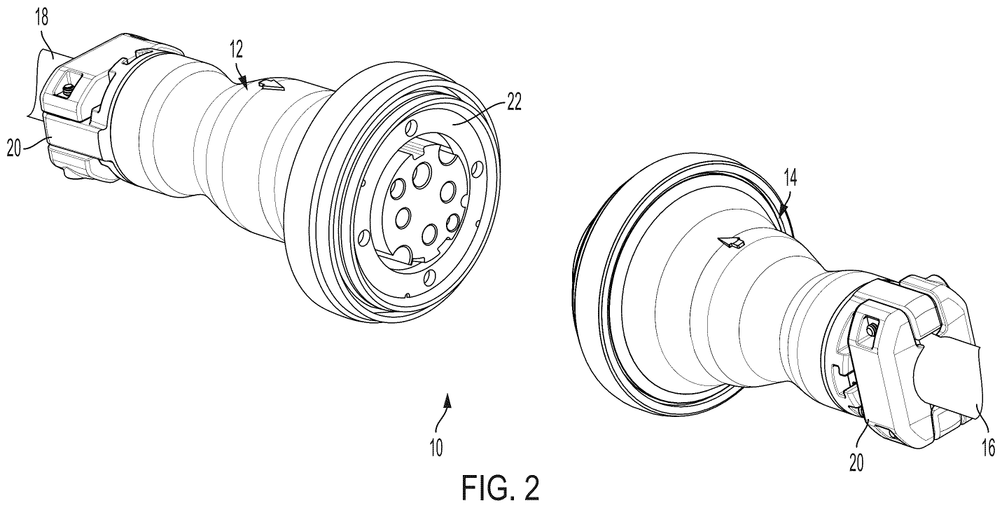

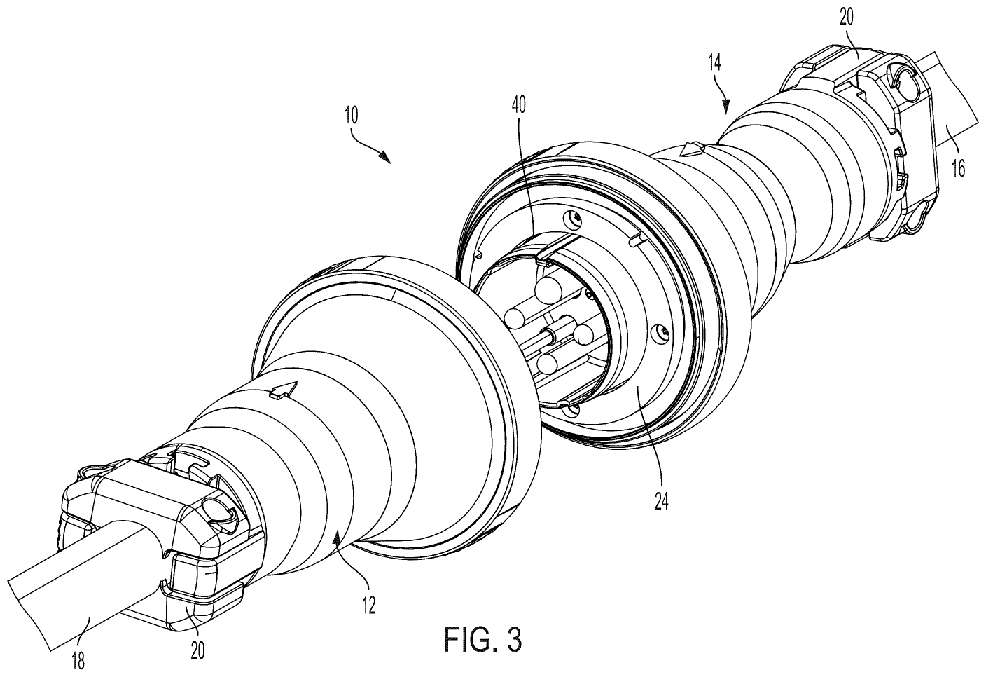

Referring to the drawings and in particular with simultaneous reference to FIGS. 1-5B, an exemplary embodiment of a breakaway electrical connector according to the present disclosure is shown and is generally referred to by reference numeral 10.

Connector 10 includes a line side 12 and a load side 14 connected to line conductor 16 and a load conductor 18, respectively. In the illustrated embodiment, sides 12, 14 each have a water-tight compression fitting 20 for connection to conductors 16, 18. Fitting 20 allows sides 12, 14 to be wired directly to the existing conductors 16, 18 on vehicles and stationary power supplies.

Of course, it is contemplated by the present disclosure for sides 12, 14 to be connected to conductors 16, 18 in any desired manner.

Connector 10 includes a magnetic assembly 22 arranged on one of line side 12 and load side 14. In the illustrated embodiment, magnetic assembly 22 is arranged on line side 12 and a strike plate 24 is arranged on load side 14. Of course, it is contemplated by the present disclosure for magnetic assembly 22 to be arranged on load side 14 and strike plate 24 to be arranged on line side 12. Strike plate 24 can be made of any ferrous material to provide a magnetic connection with magnetic assembly 22 to mitigate inadvertent disconnection of line and load sides 12, 14.

Advantageously, connector 10 provides an industrial grade, horsepower rated connector with sides 12, 14 that are magnetically secured to one another via magnetic assembly 22 with a magnetic force that can be disconnected or broken apart when sufficient axial and/or transverse loading—such as can occur in accidental drive off situations, in the case of motor vehicles, or equipment relocation situations, in the case of commercial equipment—without damage to either side 12, 14, conductors 16, 18, or fittings 20.

Stated differently, the magnetic connection provided to connector 10 by magnetic assembly 22 is sufficient to maintain sides 12, 14 connected to one another during normal operation, but this magnetic connection is less than the pull-apart strength of sides 12, 14 and of fittings 20, as well as being less than a tensile strength of conductors 16, 18. As used herein, the term “pull-apart strength” shall mean the strain relief limits of fittings 20.

In the illustrated embodiment, connector 10 is shown as a four-contact connector where line and load sides 12, 14 each have a ground contact 26, a neutral contact 28, and one or more hot contacts 30, 32 (two shown). Of course, it is contemplated by the present disclosure for connector 10 to be configured with any desired configuration of contacts. Moreover, it is contemplated by the present disclosure for connector 10 to be configured for use with one or more different types of currents and/or voltages such as, but not limited to, alternating current (AC) power with voltages from 12 VAC to 600 VAC and others, or direct current (DC) power having voltages from 3 VDC to 300 VDC and others.

Connector 10 can include one or more alignment features and/or one or more auxiliary contacts. In the illustrated embodiment, line and load sides 12, 14 each have one or more alignment features and/or contacts 34 (two shown), which are shown as prongs and openings, respectively.

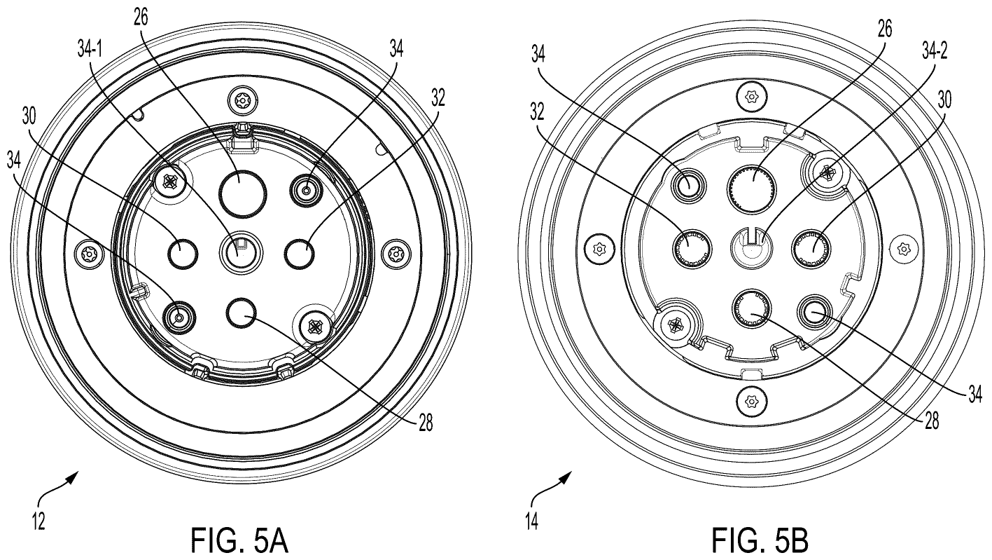

In other embodiments, connector 10 can have the alignment features 34-1, 34-2 that are centrally located as shown in FIGS. 5A-5B. Features 34-1, 34-2 are shaped and/or positioned to ensure proper connection of line side 12 and load side 14 to one another via alignment of contacts 26, 28, 30, 32.

In the illustrated embodiment, line side 12 has a guide feature shown as a protrusion 34-1 and load side 14 has a corresponding guide feature shown as an opening 34-2. Protrusion 34-1 and opening 34-2 are shaped so that the protrusion can in only be received in the opening in one orientation, which ensures the contacts of line side 12 and load side 14 are aligned to one another during assembly.

In the illustrated embodiment, features 34-1, 34-2 are shown centrally arranged in sides 12, 14, respectively. Of course, it is contemplated by the present disclosure for features 34-1, 34-2 to have any desired location.

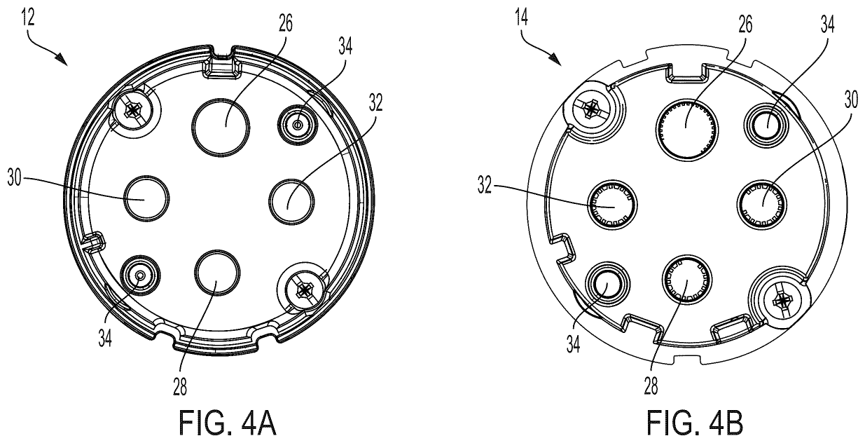

Additionally, features 34-1, 34-2 are shown in the illustrated embodiment in combination with feature 34 of FIGS. 4A-4B. Of course, it is contemplated by the present disclosure for features 34-1, 34-2 to be used independently without feature 34.

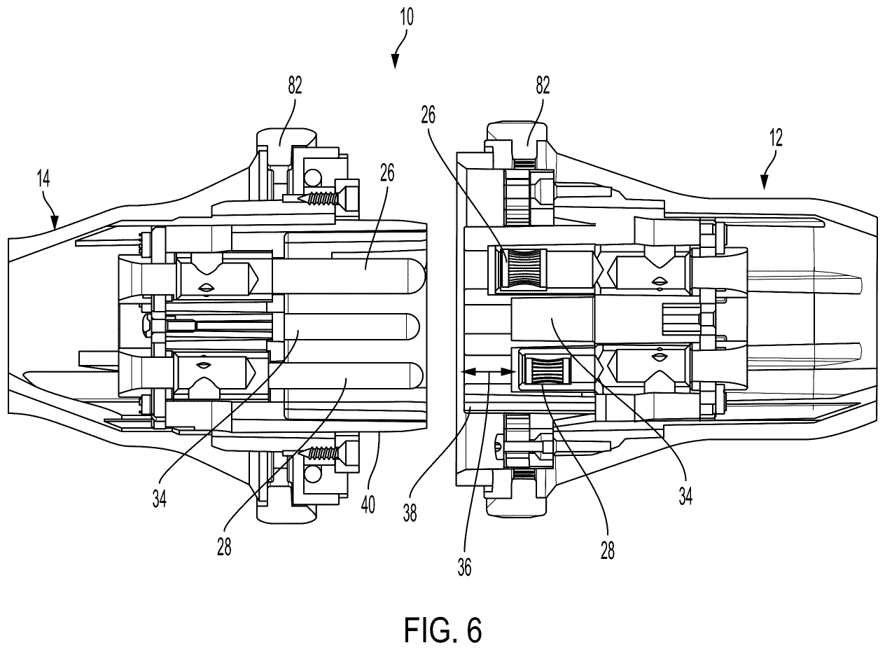

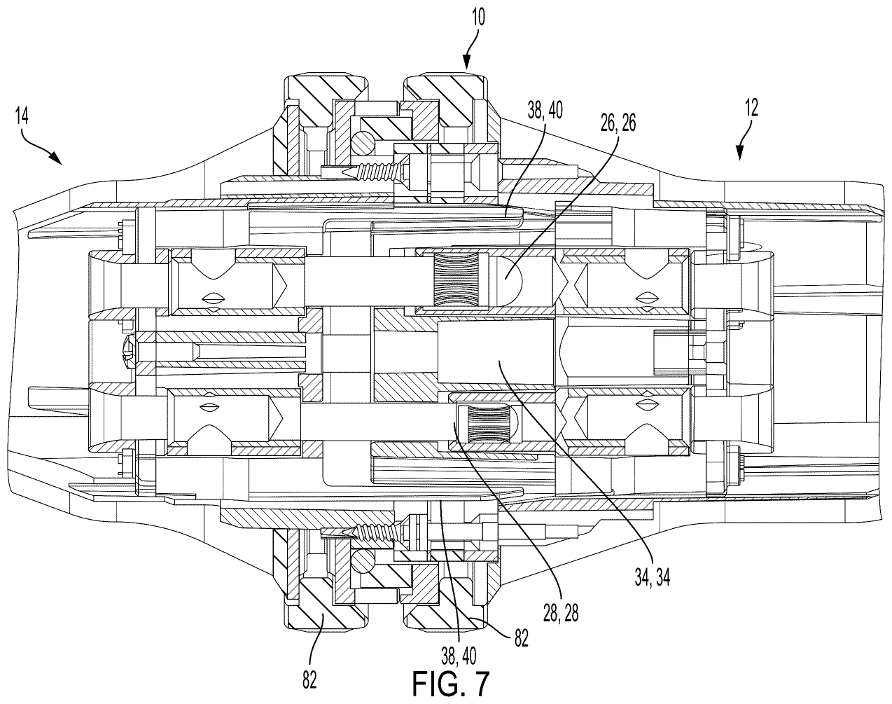

In some embodiments, connector 10 can include a bumper 82 on line side 12 and/or load side 14 as shown in FIGS. 6 and 7. Bumper 82 can be formed of elastomeric material to provide impact protection to connector 10. In some embodiments, bumper 82 can be separately molded from line and load sides 12, 14 and secured thereto in a known manner. In the alternative, it is contemplated by the present disclosure for bumper 82 to be co-molded with line and/or load sides 12, 14.

In some embodiments, connector 10 is configured to minimize arc propagation between the contacts of line and load sides 12, 14 during movement between the connected and disconnected states. An exemplary embodiment of the arc propagation mitigation of connector 10 is shown with simultaneous reference to FIGS. 6-7.

Line side 12 includes female contacts 26, 28, 30, 32 recessed within the line side by a distance 36 and a recess 38 defined around the contacts. Load side 14 includes a shroud 40 that extends outward around male contacts 26, 28, 30, 32. Recess 38 is defined in an electrically insulating material of load side 14 and shroud 40 is also an electrically insulating material of line side 12.

Advantageously, connector 10 is configured and dimensioned so that recess 38 receives shroud 40 prior to male contacts 26-32 being within an electrically communicating distance of female contacts 26-31. In this manner, any arc between line and load sides 12, 14 during movement between the connected and disconnected states is captured or shrouded by shroud 40 being received in recess 38.

Connector 10 can be configured so that ground contacts 26 on sides 12, 14 mate before any of the remaining contacts 28, 30, 32 mate with one another. Further, connector 10 can be configured so that neutral contacts 28 on sides 12, 14 mate after ground contacts 26 are mated, but before hot contacts 30, 32 mate. Finally, connector 10 can be configured so that hot contacts 30, 32 on sides 12, 14 mate after ground and neutral contacts 26, 28 are mated with one another, respectively. Connector 10 is further configured to so that this order of mating (i.e., ground first, neutral second, and hot last) occurs in reverse during disconnection of line and load sides 12, 14.

Accordingly, connector 10 can be configured so that the distance each pair of mating contacts are recessed in and/or protrude from line and load sides 12, 14, respectively, provide the desired ordered mating of contacts 26-32.

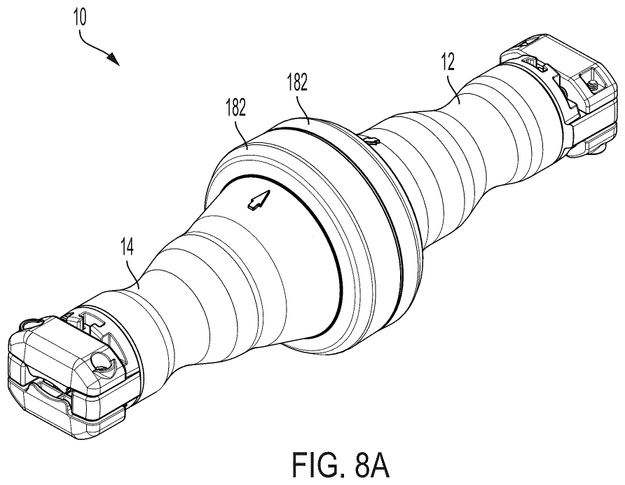

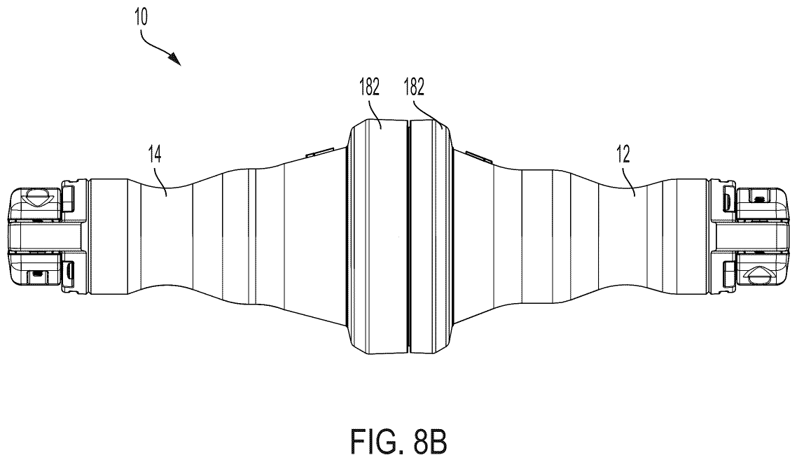

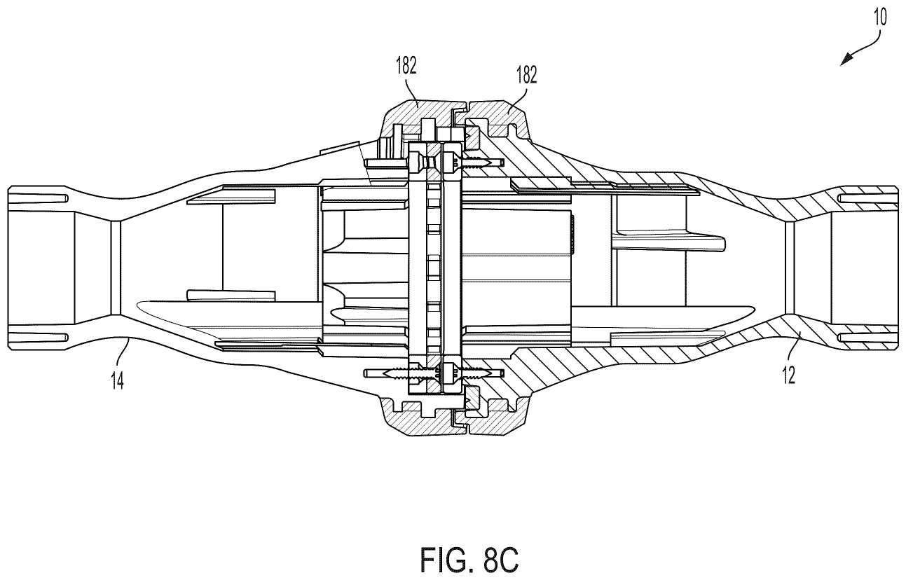

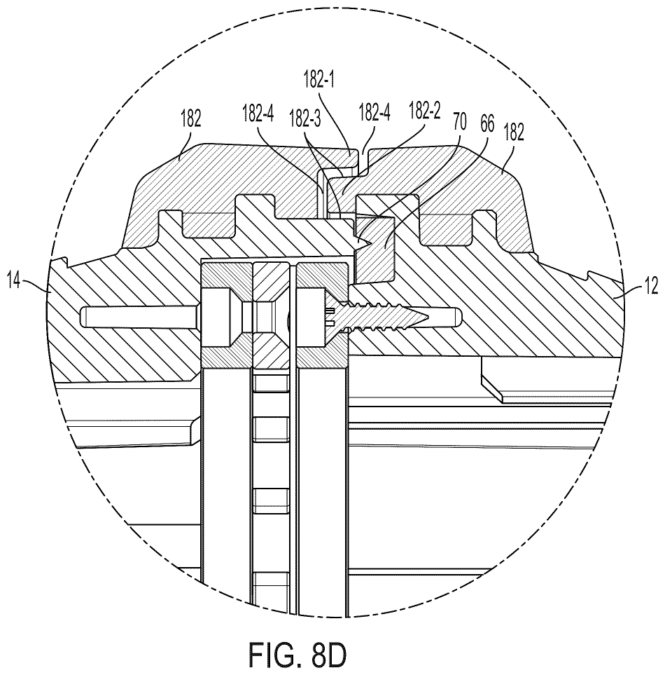

Referring now to FIGS. 8A-8D, an alternate exemplary embodiment of connector 10 is shown having an elastomeric bumper 182. Here, bumper 182, similar to bumper 82 discussed above, is configured to provide impact protection to connector 10. In addition, bumper 182 is further configured as a seal to waterproof protection to connector 10.

In some embodiments, bumper 182 can be separately molded from line and load sides 12, 14 and secured thereto in a known manner. In the alternative, it is contemplated by the present disclosure for bumper 182 to be co-molded with line and/or load sides 12, 14.

For reasons of clarity, FIGS. 8A-8D have been illustrated without various component parts that are not necessary for the understanding of bumper 182 and the waterproofing structure of connector 10.

Bumper 182 on one of the sides 12, 14 has an external extension 182-1, while the bumper on the other of the sides has an internal extension 182-2. When connector 10 is in the connected stated, internal extension 182-2 is received in external extension 182-1 in a manner configured to form a tortious path defined by at least one radial seal 182-3 (two shown) and/or at least one face seal 182-4 (two shown).

Bumper 182 can be formed of any thermoset or thermoplastic elastomer having elastic properties. Bumper 182 can be any natural or synthetic polymer including, but not limited to, one or more of natural rubber (NR), synthetic polyisoprene, isoprene rubber, polybutadiene, butadiene rubber, chloroprene rubber, polychloroprene, neoprene, butyl rubber, halogenated butyl rubbers, styrene-butadiene rubber, nitrile rubber, hydrogenated nitrile rubbers, ethylene propylene rubber, ethylene propylene diene rubber, epichlorohydrin rubber, acrylic rubber, silicone rubber, fluorosilicone rubber, fluoroelastomers, perfluoroelastomers, polyether block amides. chlorosulfonated polyethylene, ethylene-vinyl acetate, and others.

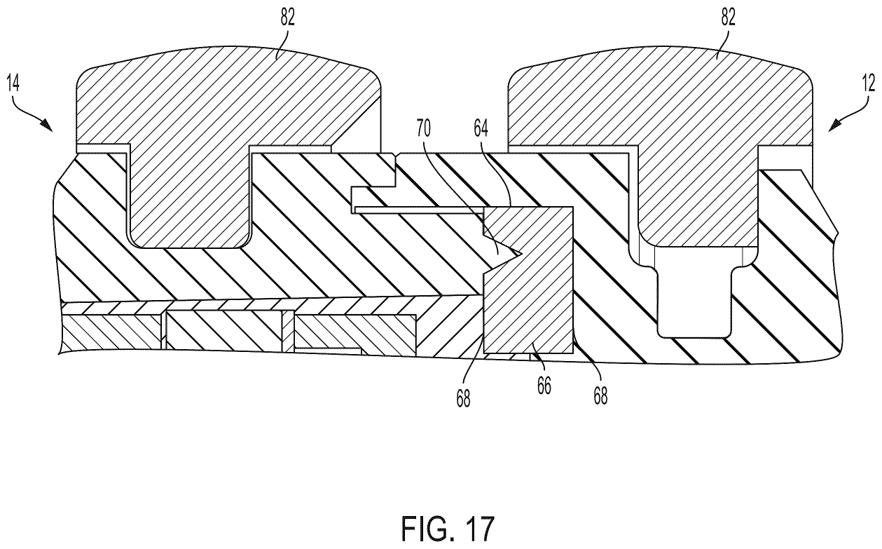

Connector 10 can, in some embodiments, include a gasket seal 66. Gasket seal 66 is shown with more clarity in FIG. 17. Gasket seal 66 can be formed of any resilient polymer material-such as but not limited to an open or closed cell foam. Gasket seal 66 forms a seal with planar surfaces 68 of line side 12 and load side 14, respectively, as well as inner radial surface 64 of the line side. In some embodiments, line side 12 and/or load side 14 can include one or more protrusions 70 (one shown) to provide additional sealing surfaces for gasket seal 66.

In the preferred embodiment illustrated, connector 10 includes bumper 182 over-molded on both line and load sides 12, 14, gasket seal 66 formed as closed cell foam in the line side, and one or more protrusions 70 on the load side, which together combine to provide impact protection and waterproofing protection.

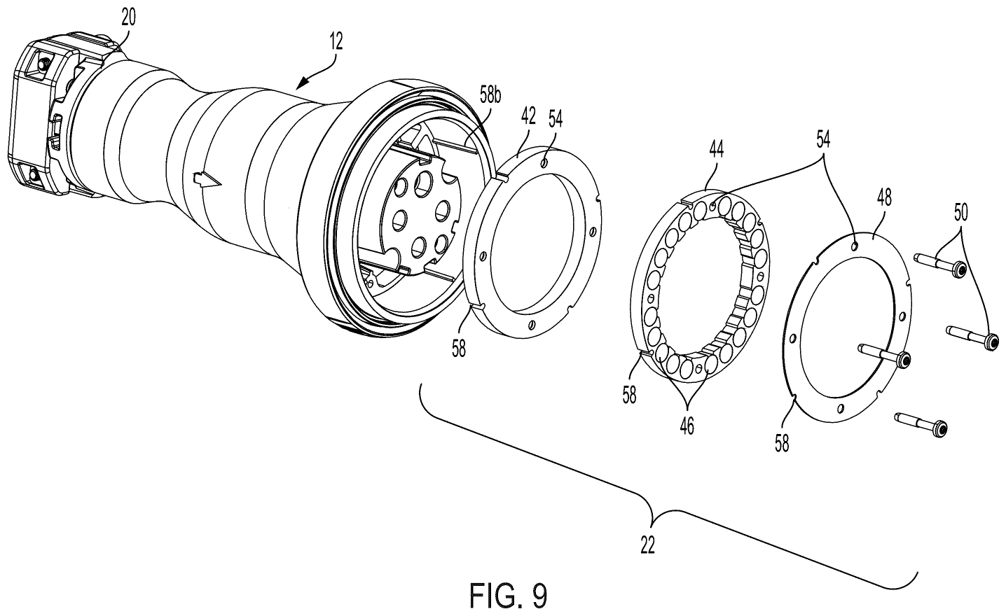

An exemplary embodiment of magnetic assembly 22 is shown and disclosed with simultaneous reference to FIGS. 9-14. Magnetic assembly 22 has a first or base plate 42, a magnet holder 44, a plurality of magnets 46 in the holder, and a second or top plate 48. Magnetic assembly 22 provides a magnetic holding force with strike plate 24 to connector 10 when in the connected state.

Magnetic assembly 22 can be secured to line side 12 by any mechanical, adhesive, or thermal connection method. In the illustrated embodiment, magnetic assembly 22 includes one or more mechanical fasteners 50 securing the assembly to line side 12.

It should be recognized that connector 10 is described by way of example as configured with line side 12 having magnetic assembly 22 and load side 14 having strike plate 24. Of course, it is contemplated by the present disclosure for connector 10 to be configured so that line side 12 has strike plate 24 and load side 14 has magnetic assembly 22.

Magnetic assembly 22 has a central opening 52 sized and positioned so that electrical contacts 26-32 of line side 12 is received within the central opening. Magnetic assembly 22, and line side 12, are preferably configured to minimize induction of an electrical current in contacts 26-32 due to the magnetic field from of magnets 46. Moreover, magnetic assembly 22, and line side 12, are preferably sized and dimensioned to minimize propagation due to electrical current passing through contacts 26-32 from interfering or minimizing the magnetic field of magnetic assembly 22.

In some embodiments, magnetic assembly 22 includes one or more fastener openings 54 (four shown). As shown in FIG. 9, fastener openings 54 are present in first plate 42, holder 44, and second plate 46. Openings 54 are sized and configured so that mechanical fasteners 50 pass through magnetic assembly 22 and secure the magnetic assembly to line side 12.

In the same or other embodiments, magnetic assembly 22 includes one or more second alignment feature 58 that cooperate with corresponding alignment features 58b in line side 12 to ensure that the magnetic assembly is radially arranged (e.g., clocked) within the line side in a desired position. As shown in FIG. 9, second alignment feature 58 is present on first plate 42, holder 44, and second plate 46.

First and second plates 42, 48 are made of any ferrous material where magnetic assembly 22 is formed with magnets 46 sandwiched between and in magnetic communication with the first and second plates, which is believed to maximize the magnetic attraction forces between the assembly and strike plate 24. In the illustrated embodiment, second plate 48 is configured with an inner and outer dimension that completely covers a top surface of holder 44 and, in the alternative, at least completely covers a top surface of magnets 46 in the holder.

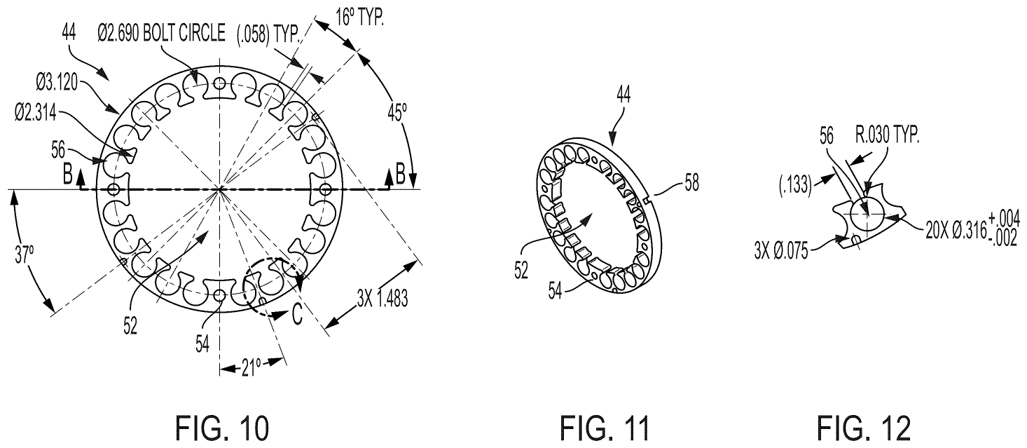

An exemplary embodiment of holder 44 is shown in FIGS. 10-12. Holder 44 includes central opening 52 and a plurality of discrete magnet locations 56. Holder 44 can be made of any magnetic or non-magnetic material. In some embodiments, holder 44 is made of non-magnetic molded polymer. In other embodiments, holder 44 is made of non-magnetic molded polymer that includes embedded magnetic material. In these embodiments, holder 44 secures magnets 46 in locations 56 by a press fit and/or an interference fit—where the resilience of the holder maintains the magnets in the locations. In still other embodiments, holder 44 is made of magnetic material and is integrally formed with first plate 42.

Magnets 46 are two-pole magnets having both a positive or southern polarity and a negative or northern polarity. Magnetic assembly 22 can be configured with adjacent magnets 46 arranged with poles in opposite directions or in the same direction.

The present application tested the pull force to optimize the available pull force between magnetic assembly 22 and strike plate 24.

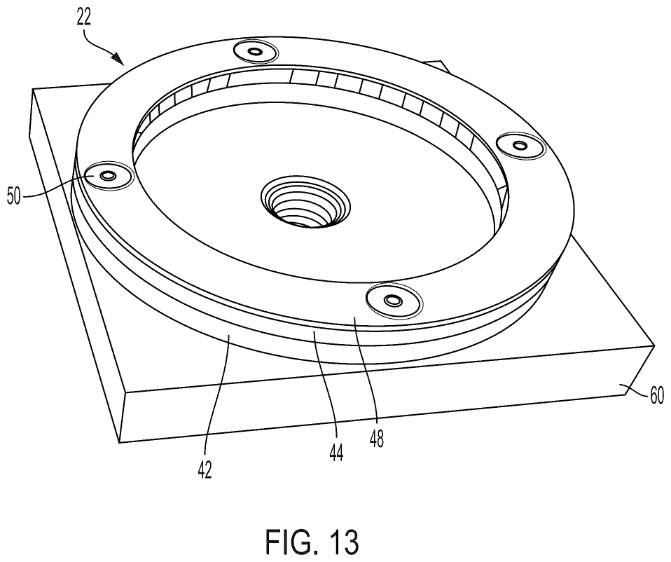

FIG. 13 shows a pull force testing configuration for testing exemplary embodiments of magnetic assemblies 22 according to the present disclosure. To remove frictional forces from the test results, different configurations of magnetic assembly 22 were tested in the absence of the various components of connector 10. Rather, magnetic assembly 22 was magnetically coupled to a test plate 60 of a pull tester such as that available from the Tinius Olsen testing machine company.

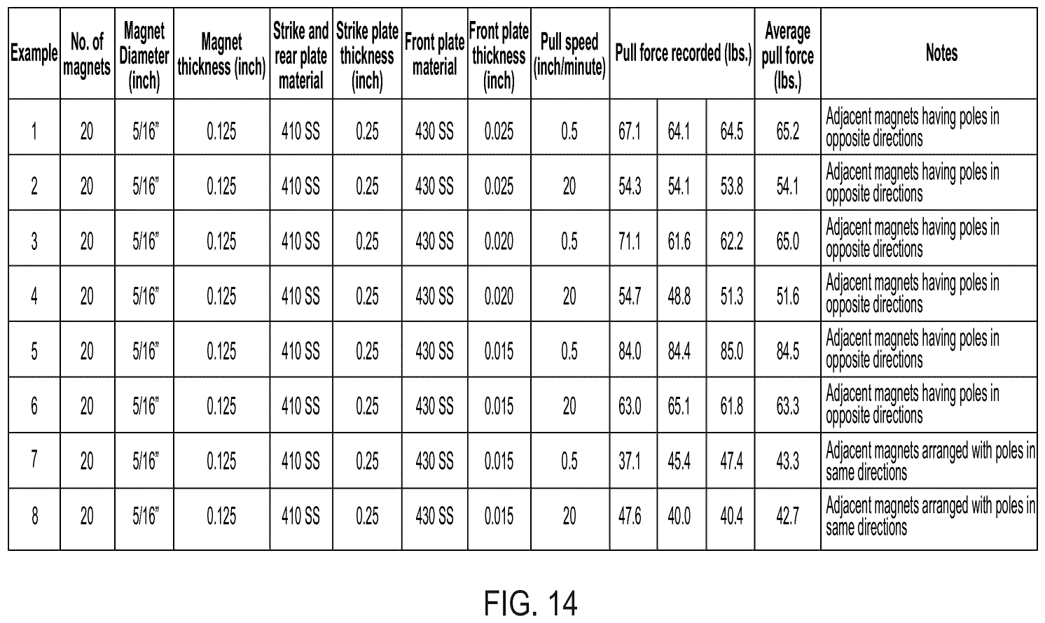

FIG. 14 illustrates pull force test results according to the present disclosure where the thickness of front or second plate 48 was varied in Example Tests 1-8, the speed of the separation test was varied in Example Tests 1-8, and the polarity arrangement of the magnets 46 was varied in Example Tests 7-8.

Surprisingly, the present disclosure determined that second plate 48 provided larger pull forces as to strike plate 60 when the second thickness of the second plate was minimized and the polarity of magnets 46 were arranged with an even number of magnets having the poles in opposite directions—at both slow and rapid pull speeds.

Saturation as used herein is the state reached when an increase in the magnetic field no longer increases the magnetization of the plate. Initially, it was theorized by the present disclosure that magnetic assembly 22 would provide the greatest pull force with respect to strike plate 24 by a configuration where second plate 48 was fully saturated-namely had second thickness at or greater than the saturation thickness and/or when the poles of the magnets 46 were arranged in the same direction.

However and as shown in FIG. 14, the testing of the present disclosure surprisingly determined that second plate 48 provided larger pull forces as to strike plate 60 when the second thickness of the second plate was minimized and the polarity of magnets 46 were arranged with poles in opposite directions—at both slow and rapid pull speeds.

Thus and in some embodiments, first plate 42 has a first thickness that is dimensioned, with respect to the magnet flux of magnets 46, to preferably ensure the first plate is fully saturated by the magnetic flux. In contrast, second plate 48 has a second thickness that is dimensioned, with respect to the magnet flux of magnets 46, to preferably ensure the second plate is not fully saturated by the magnetic flux.

In one exemplary embodiment, connector 10 is configured such that magnetic assembly 22 includes magnets 46 that are and are present in a range of between 5 and 35, preferably in a range of between 10 and 25 magnets, and most preferably 20 magnets. Magnets 46 are preferably cylindrical in shape, but of course magnets of any shape or combination of shapes that provide the desired pull forces are contemplated by the present disclosure.

When cylindrical, magnets 46 can have a diameter of between 1/16″ to 1″, more preferably between 3/16″ and ⅝″, with 5/16″ being most preferred. Also when cylindrical, magnets 46 can have a thickness of between 0.05″ to 0.25″, more preferably between 0.10″ to 0.20″, with 0.125″ being most preferred.

Strike plate 24, first plate 42, and second plate 48 can be made of any ferromagnetic material. In some exemplary embodiments, strike plate 24 and first plate 42 are made of stainless steel, more preferably ferritic or martensitic stainless steels, with 410 stainless steel being most preferred. In other embodiments, strike plate 24 and first plate 42 are made of soft ferromagnetic alloys such as, but not limited to, mu-metal or other nickel-irons. Strike and second plates 24, 42 can be made of the same or different materials.

In some exemplary embodiments, second plate 48 is preferably made of stainless steel, more preferably ferritic stainless steels, with 430 stainless steel being most preferred. Second plate 48 can have the second thickness in a range between 0.40″ and 0.005″, preferably between 0.30″ and 0.01″, more preferably between 0.25″ and 0.015″, with 0.015″ being most preferred.

Thus and in some embodiments, first plate 42 has a first thickness that is dimensioned, with respect to the magnet flux of magnets 46, to preferably ensure the first plate is fully saturated by the magnetic flux. In contrast, second plate 48 has a second thickness that is dimensioned, with respect to the magnet flux of magnets 46, to preferably ensure the second plate is not fully saturated by the magnetic flux.

Connector 10 is configured to provide a pull force between magnetic assembly 22 and strike plate 24 of between 45 and 95 pounds, more preferably between 50 and 90 pounds, with between 60 and 85 pounds being most preferred.

A method of assembling an exemplary embodiment of connector 10 is now described with reference again to FIG. 9. Magnets 46 are positioned in locations 56 of holder 44 and second plate 48 is coupled to the holder by the magnets—define a subassembly of the magnetic assembly.

First plate 42 can be coupled to holder 44 by magnets 46 to further define the subassembly—with the subassembly being secured to line side 12 by mechanical fasteners 50. In other embodiments, first plate 42 can be positioned in line side 12 and the subassembly of holder 44, magnets 46, and second plate 48 can be secured to line side 12 by mechanical fasteners 50 with the first plate positioned between the holder and the line side.

In some embodiments, first plate 42 and strike plate 24 can be identical to reduce the number of components to assemble connector 10.

Connector 10 can be configured to provide seal between line and load sides 12, 14. The seal is formed radially outside of magnetic assembly 22 and, thus, radially outside of the connection between contacts 26-32 on the line and load sides. In some embodiments, connector 10, by way of one or more seals, is configured to meet International Electrotechnical Commission (IEC) Standard 60309-1 and/or IEC 60309-2. In other embodiments, connector 10, by way of one or more seals, is configured to provide one or more of splash-proof protection, waterproof protection, and jet-proof protection when detached and/or when mated and/or during the mating process. For example, in some embodiments connector 10 is configured to meet the waterproof standard known as NEMA 4 and/or NEMA 4X established by the National Electrical Manufacturers Association (NEMA), which requires exclude at least 65 GPM of water from a 1 inch nozzle delivered from a distance not less than 10 feet for 5 minutes.

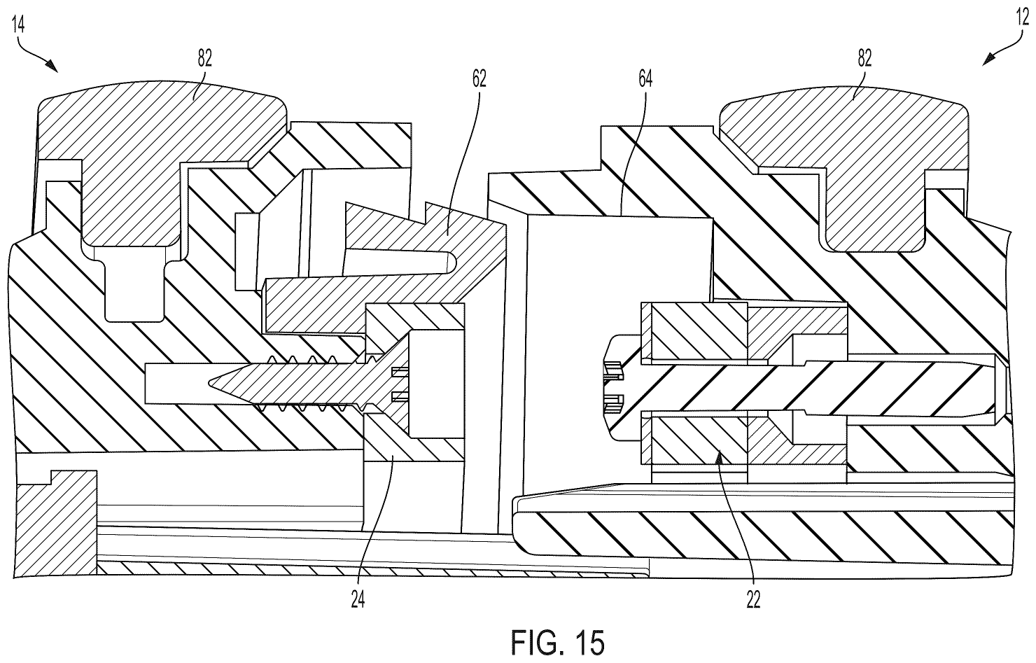

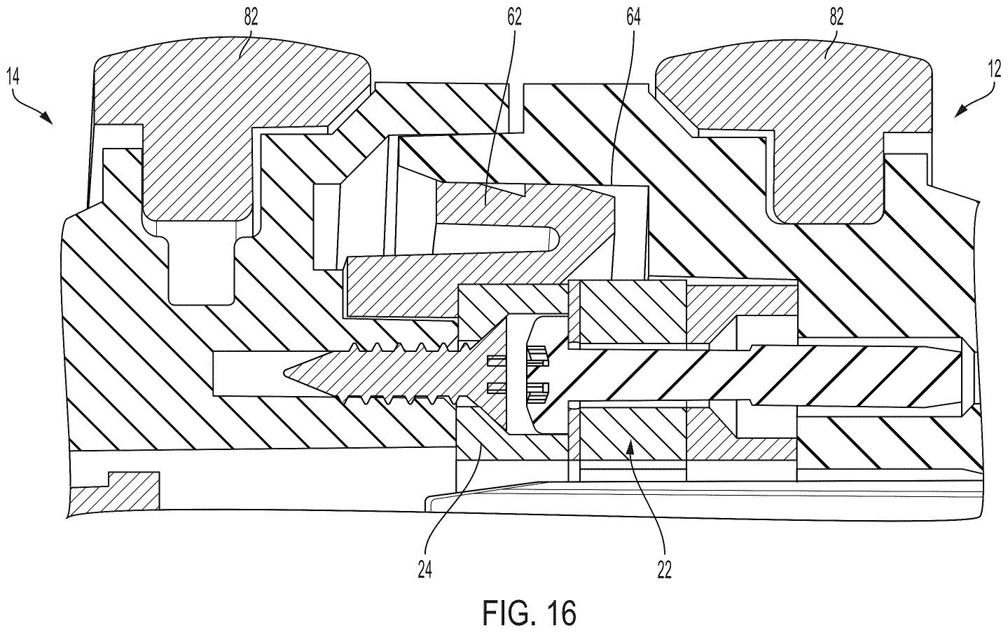

For example, connector 10 is shown in FIGS. 15-16 with a lip seal 62 held in position in load side 14 by strike plate 24. Lip seal 62 can be formed of any resilient polymer material such as but not limited to natural or synthetic rubber. Lip seal 62 forms a seal with an inner radial surface 64 of line side 12.

In another example, connector 10 is shown in FIG. 17 having a gasket seal 66. Gasket seal 66 can be formed of any resilient polymer material-such as but not limited to an open or closed cell foam. Gasket seal 66 forms a seal with planar surfaces 68 of line side 12 and load side 14, respectively, as well as inner radial surface 64 of the line side.

In some embodiments, line side 12 and/or load side 14 can include one or more protrusions 70 (one shown) to provide additional sealing surfaces for gasket seal 66.

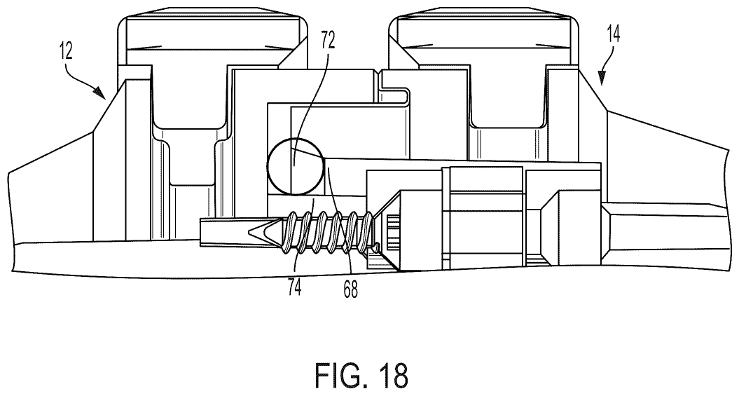

In yet another example, connector 10 is shown in FIG. 18 having an O-ring seal 72. O-ring seal 72 can any resilient polymer material such as but not limited to natural or synthetic rubber. O-ring seal 72 forms a seal with an outer radial surface 74 of load side 14 as well as planar surfaces 68 of line side 12 and load side 14.

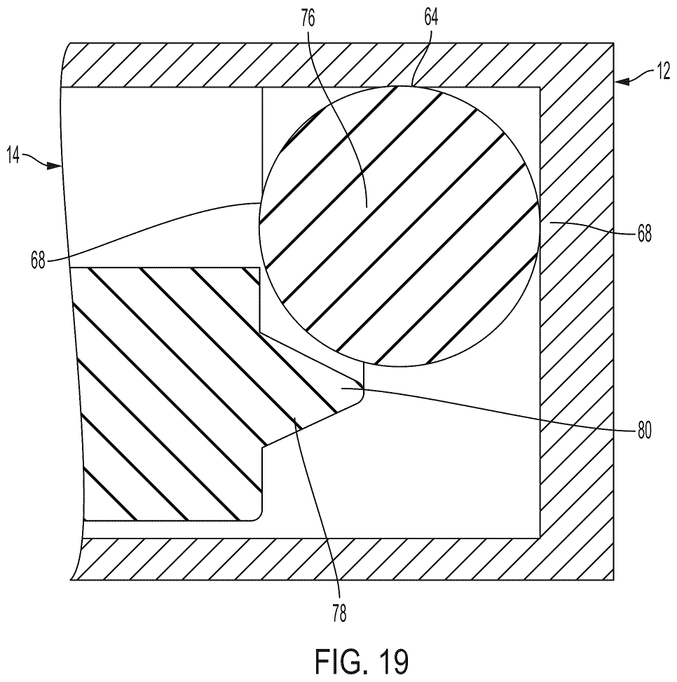

In still another example, connector 10 is shown in FIG. 19 having an O-ring seal 76. O-ring seal 76 can any resilient polymer material such as but not limited to natural or synthetic rubber. O-ring seal 76 forms a seal with inner radial surface 64 of line side 12 as well as planar surfaces 68 of line side 12 and load side 14.

In some embodiments, line side 12 and/or load side 14 can include a protrusion 78 to provide an additional radial sealing surface 80 for O-ring seal 76.

In still another embodiment, one or more of lip seal 62, gasket seal 66, O-ring seal 72, and O-ring seal 76 can be combined together or individually with bumper 182 discussed above with respect to FIGS. 8A-8C,

Accordingly, connector 10 provides the advantage of eliminating costly and untimely repairs of damaged electrical wiring systems due to accidental drive off while sides 12, 14 are connected. Connector 10 further provides these benefits together with an easy to mate configuration, which provides multiple levels of security to eliminate incorrect mating of the line to the load yet can break away under excessive stress. Moreover, connector 10 further provides these benefits together in a simple to use manner that shrouds arcing during the mating of the line and load sides 12, 14. Further and in this manner, connector 10 is configured and adapted for use with electrical commercial equipment (e.g., food service device) to disconnect the equipment from the power source so that it can be moved for cleaning activities such as occurs in food service and various manufacturing environments, then easily reconnected to the power source.

It should be noted that connector 10 is disclosed herein above with respect to bespoke breakaway line and load sides 12, 14. However, it has been determined by the present disclosure that there is a need for assemblies that are configured to convert prior art electrical connectors into breakaway connectors.

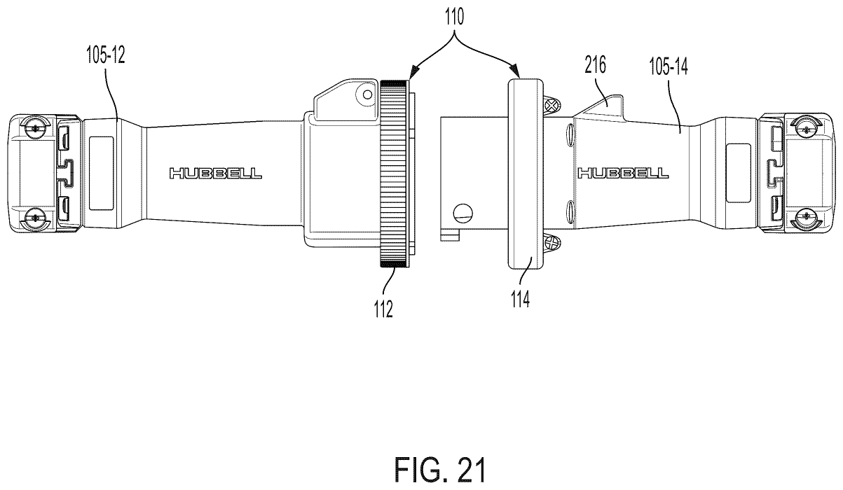

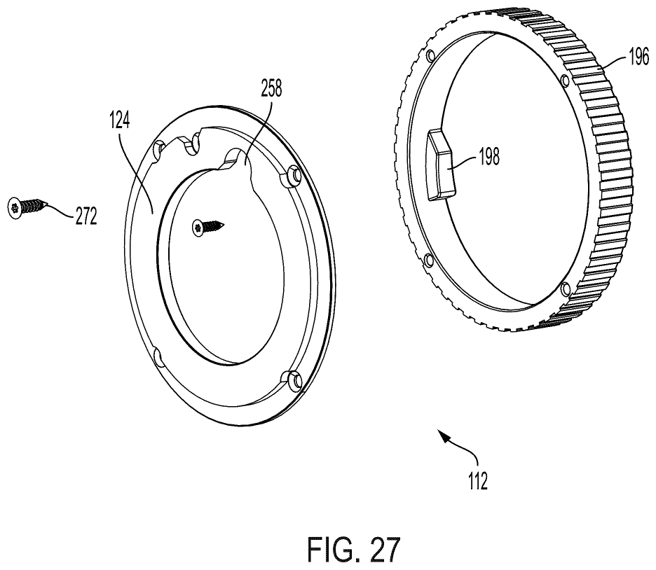

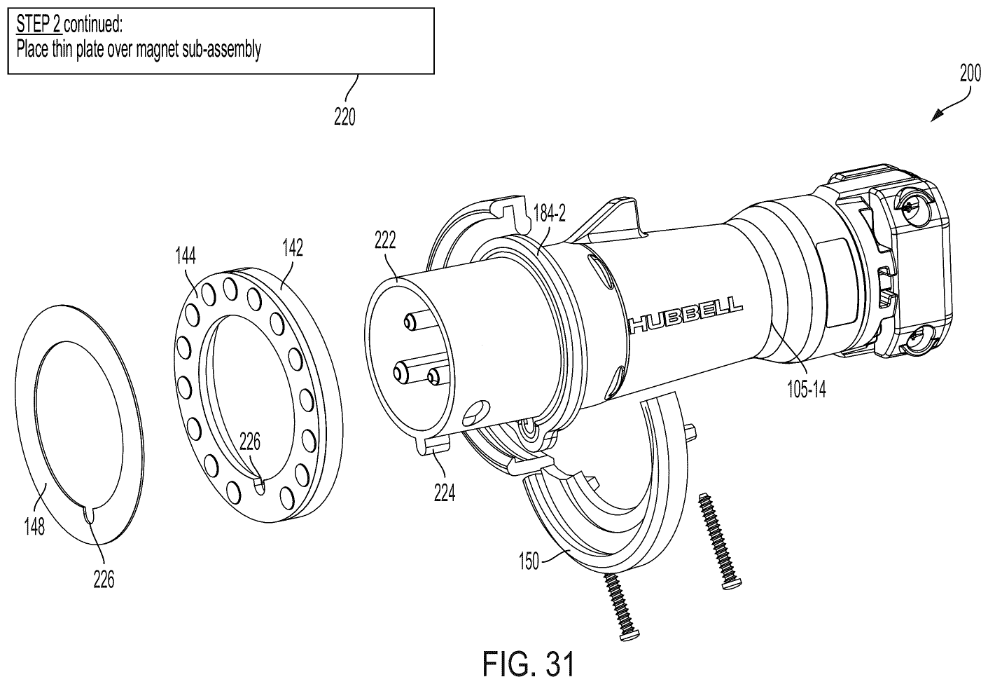

Accordingly, an exemplary embodiment of a breakaway retrofit assembly 110 according to the present disclosure is disclosed with simultaneous reference to FIGS. 21-36. Here, component parts performing similar and/or analogous functions to those of connector 10 are labeled in multiples of one hundred to those of connector 10.

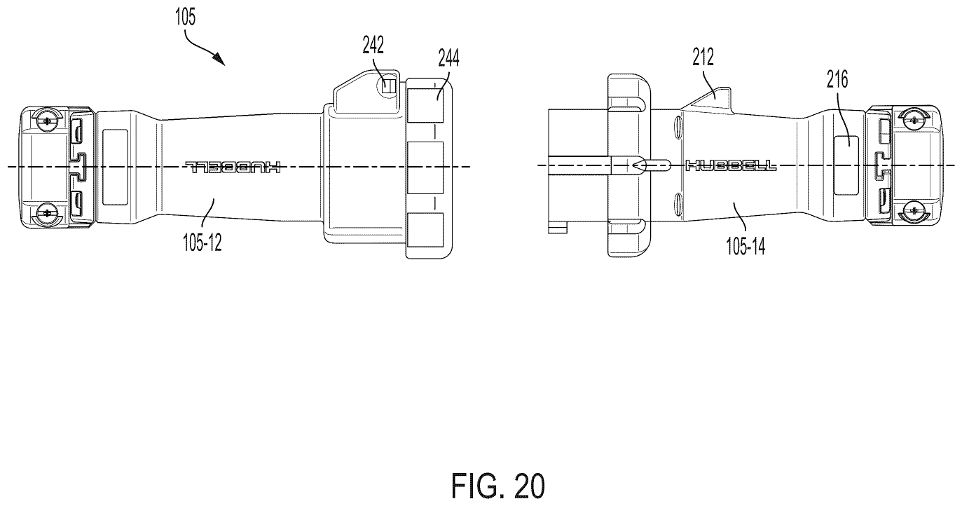

Breakaway retrofit assembly 110 is shown in use with a prior art electrical connector 105 shown in FIG. 20, which includes line side 105-12 and load side 105-14.

For ease of discussion, electrical connector 105 is shown as a watertight pin and sleeve electrical connector that is commercially available from Applicant. Of course, it is contemplated by the present disclosure for assembly 110 to find use with other prior art connectors such as, but not limited to, those having a line side configured as a wall outlet.

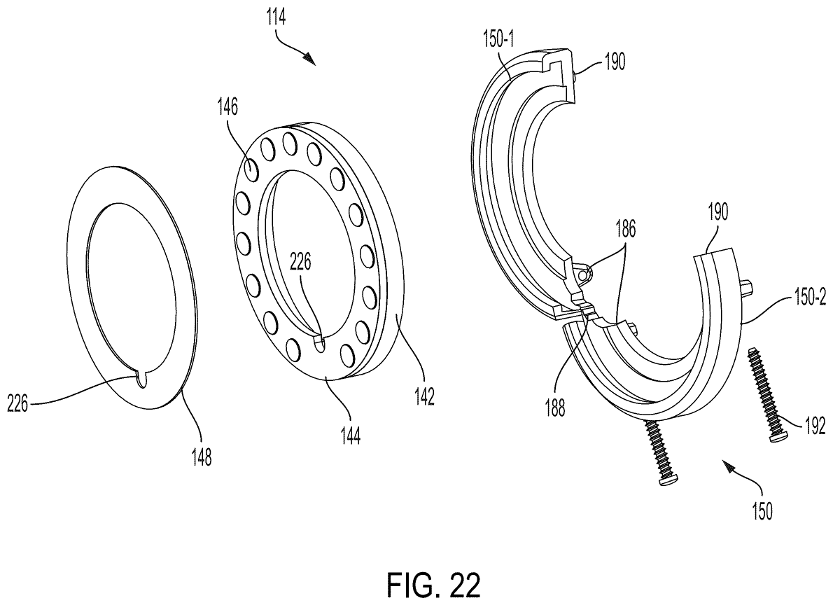

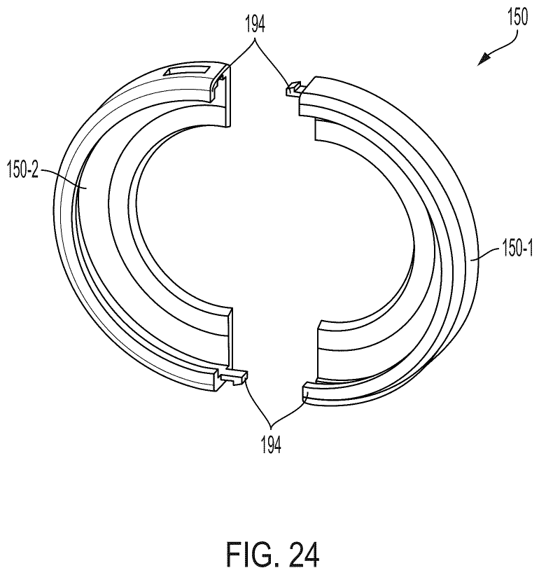

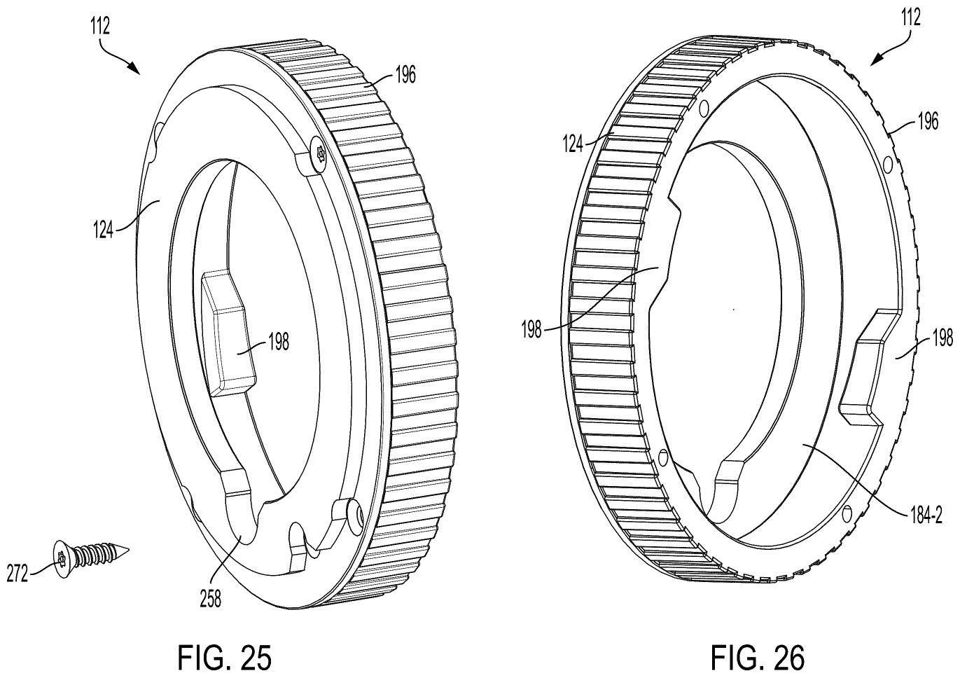

Breakaway retrofit assembly 110 has load side components 114 shown in FIGS. 22-24 and line side components 112 shown in FIGS. 25-27. Advantageously, line and load side components 112, 114 are configured to be installed in the field to preexisting connectors 105. In this manner, assembly 110 can be used to retrofit prior art connectors 105 to provide the desired breakaway functionality discussed above with respect to connector 10.

Load side components 114 include a first or base plate 142, a magnet holder 144, a plurality of magnets 146, a second or top plate 148, and a retaining ring 150, which secures the load side components 114 to the load side of connector 105.

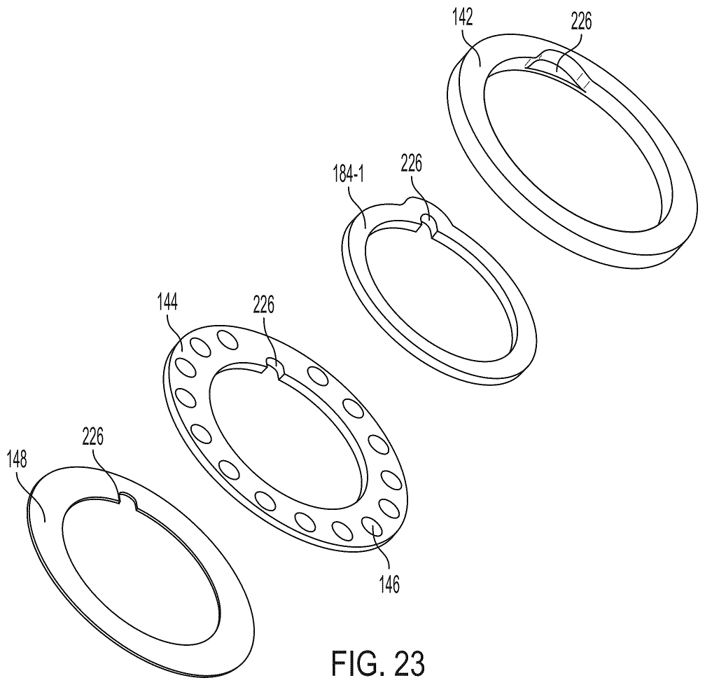

In some embodiments, load side components 114 can further include a first friction gasket 184-1 between base plate 142 and magnet holder 144 as shown in FIG. 23. Friction gasket 184-1 can be made of any polymer or rubber material and has an inner diameter that forms a friction fit with an outer diameter of connector 105.

Retaining ring 150 is configured to engage with a feature of connector 105 to secure load side components 114 to the connector 105. Stated differently, connector 105 need not be modified—but rather ring 150 can be opened then closed around the load side 105-14 of connector 105 so as to engage an existing feature of the connector 105 and secure the load side components 114 to the connector 105.

Ring 150 is shown in FIG. 22 having two sections 150-1, 150-2 secured to one another at one end 186 by a living hinge 188 and to one another at the free ends 190 by one or more fasteners 192. Ring 150 is shown in FIG. 24 having two or more sections 150-1, 150-2 secured to one another by one or more interlocking features 194. Of course, it is contemplated by the present disclosure for the sections of ring 150 to be connected to one another in any desired manner including, but not limited to, mechanical fasteners, adhesive fasteners, and others. Ring 150 can be formed of any desired material and in some embodiments is formed from molded nylon.

As discussed in detail above with respect to connector 10, base and top plates 142, 148 are formed of any ferromagnetic material. In some exemplary embodiments, base plate 142 is made of stainless steel, more preferably ferritic or martensitic stainless steels, with 410 stainless steel being most preferred. In other embodiments, first plate 142 is made of soft ferromagnetic alloys such as, but not limited to, mu-metal or other nickel-irons.

Top plate 148 can be made of the same or different materials. In some exemplary embodiments, top plate 148 is preferably made of stainless steel, more preferably ferritic stainless steels, with 410 stainless steel or mu-metal being most preferred.

In embodiments containing mu-metal, the mu-metal can have varying contents of Ni. In some embodiments, the Ni content ranges from 70% to 90% with between 75% to 80% being preferred. The remaining content can include iron, copper, chromium, molybdenum, and any combinations thereof.

Line side components 112, shown in FIGS. 25-27, include a strike plate 124 and a locking ring 196, which secures the line side components 112 to the line side 105-12 of connector 105.

In some embodiments, line side components 112 can further include a second friction gasket 184-2 on a bottom of strike plate 124 as shown in FIG. 26. Friction gasket 184-2 can be made of any polymer or rubber material and has an inner diameter that forms a friction fit with an outer diameter of connector 105.

Locking ring 196 is configured to engage with a feature of connector 105 to secure line side components 112 to connector 105. Stated differently, connector 105 need not be modified—but rather ring 196 can be positioned around the line side 105-12 of connector 105 and rotated so as to engage an existing feature of the connector 105 and secure the line side components 112 to the connector 105.

In the illustrated embodiment, ring 196 is shown having one or more cam shoulders 198 configured to engage and secure line side components 112 to an existing feature of connector 105 during rotation of ring 196 with respect to connector 105. Ring 196 can be formed of any desired material and in some embodiments is formed from molded nylon.

In some embodiments, line side components 112 can further include a mechanical fastener-such as one or more screws as shown in FIG. 25—that secures ring 196 to connector 105. Here, the connector 105 can be field modified by drilling a hole to receive the screws and/or the screws can be self-tapping.

In other embodiments, connector 105 can be formed with the hole formed therein during its manufacture so that the connector can be used either with or without the assembly 110.

As discussed in detail above with respect to connector 10, strike plate 124 is formed of any ferromagnetic material. In some exemplary embodiments, strike plate 124 is made of stainless steel, more preferably ferritic or martensitic stainless steels, with 410 stainless steel being most preferred. In other embodiments, first plate 142 is made of soft ferromagnetic alloys such as, but not limited to, mu-metal or other nickel-irons.

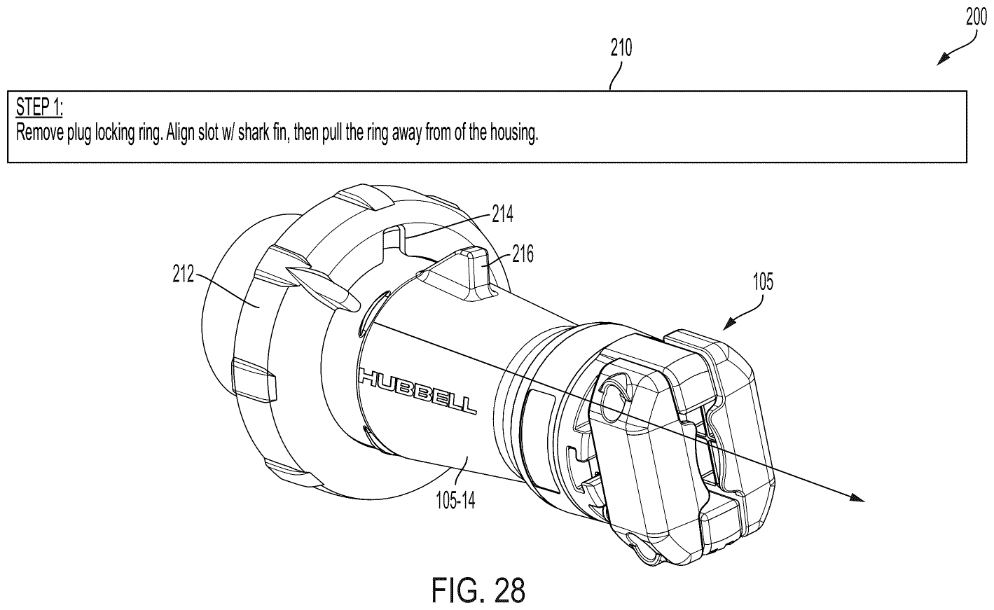

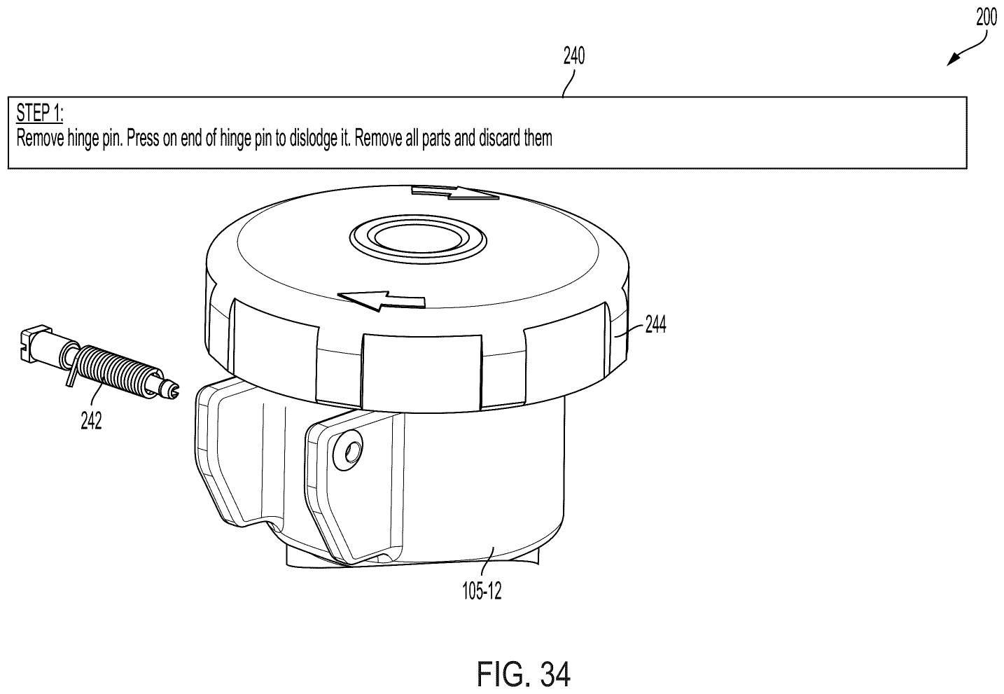

A method 200 of retrofitting or converting connector 105 using assembly 110 is described with respect to FIGS. 28-37. Here, method 200 is shown retrofitting connector 105 with load side components 114 in FIGS. 28-33 and is shown retrofitting connector 105 with line side components 112 in FIGS. 34-37.

In a first step 210 of FIG. 28, connector 105 is prepped for securing load side components 114 by removing a plug locking ring 212. The removal of plug locking ring 212 includes rotating the ring 212 until a slot 214 in the ring is clocked or radially aligned with an existing feature 216 of connector 105, then moving the ring 212 axially along the connector.

In some instances, connector 105 is electrically connected to a conductor (not shown) preventing removal of ring 212 completely. Here, ring 212 can either be left on connector 105 or can be cut off after being moved axially out of the way of the connector.

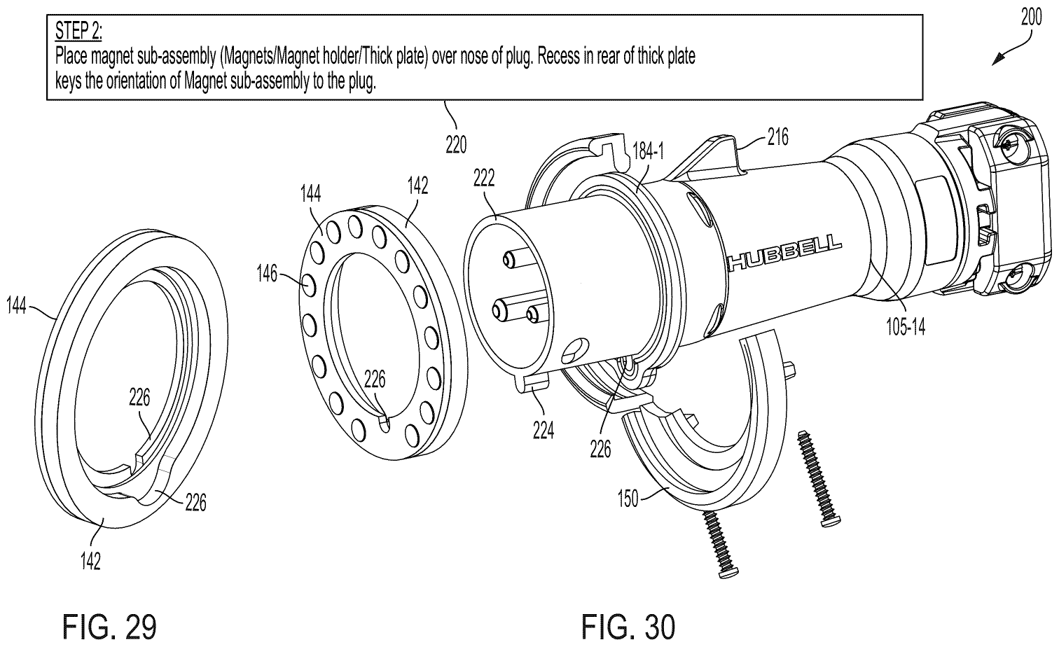

In a second step 220 of FIGS. 29-31, load side components 114 with the exception of retaining ring 150 are placed over the free end 222 of connector 105 and moved axially with the order of installation being base plate 142, then magnet holder 144, and finally top plate 148. When present, friction gasket 184-1 is installed between base plate 142 and magnet holder 144.

In some embodiments, free end 222 of connector 105 includes a feature 224 and when present, the installation further includes radially aligning openings 226 of base plate 142, friction gasket 184-1 (when present), magnet holder 144, and top plate 148 with a feature 224 of connector 105 prior to moving these components axially along connector 105.

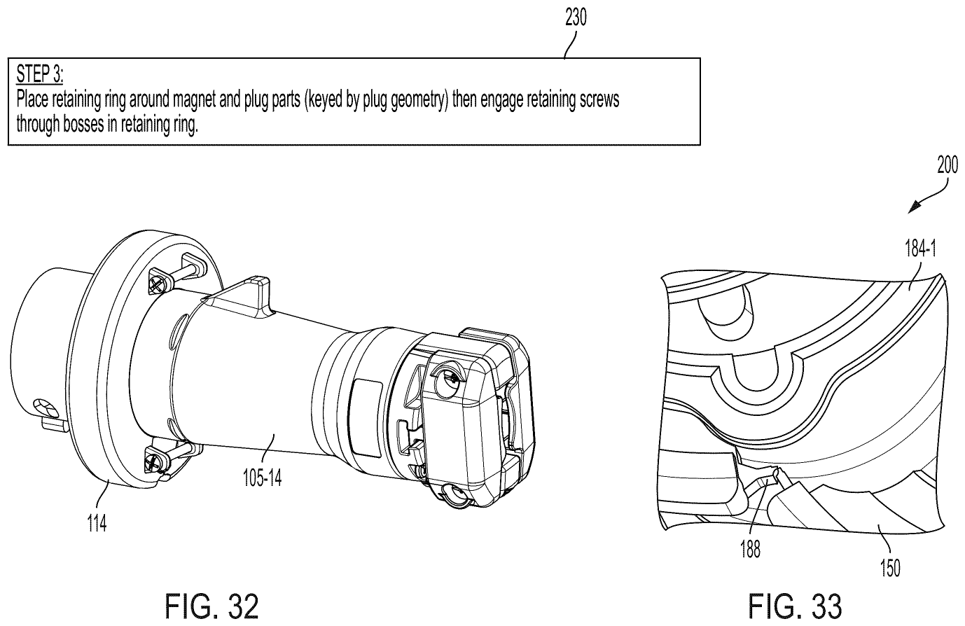

In a third step 230 of FIGS. 32-33, retaining ring 150 is placed around connector 105 and the other load side components 114. Here, retaining ring 150 has an internal geometry configured to secure the load side components 114 and connector 105 to one another.

In a next step 240 of FIG. 34, connector 105 is prepped for securing line side components 112 by removing a hinge pin 242 that secures a hinged cover 244 to the connector. For example, hinge pin 242 can be removed by pressing the pin to dislodge it from connector 105.

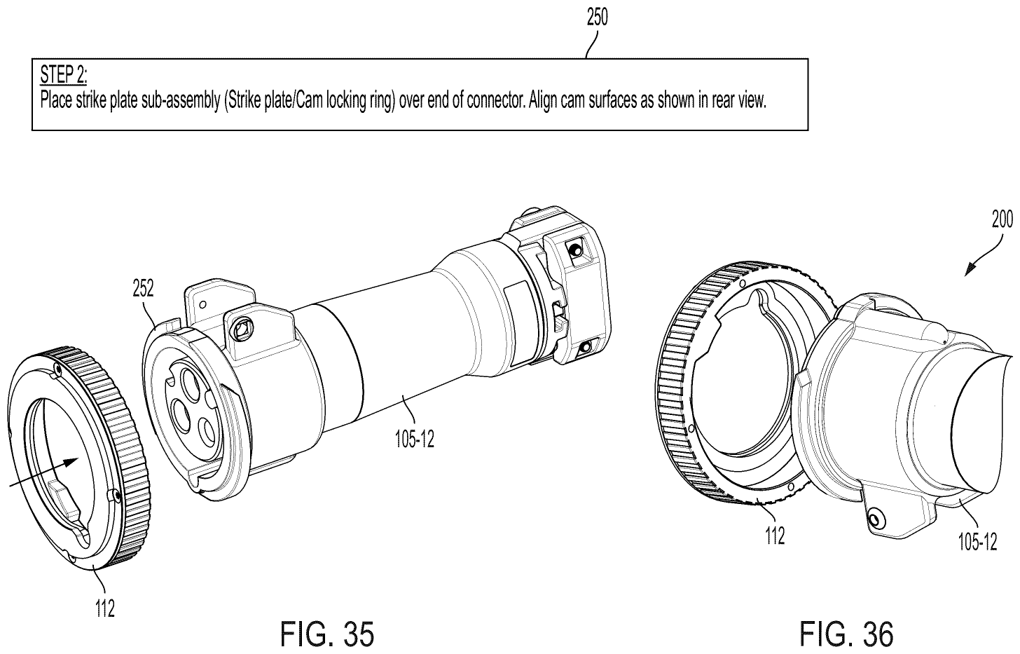

In a next step 250 of FIGS. 35-36, the line side components 112 are placed over a free end 252 of connector 105 and moved axially with the order of installation being strike plate 124 then locking ring 196. When present, friction gasket 184-2 is installed between strike plate 124 and connector 105.

Free end 252 of connector 105 includes first and second existing features 254, 256 such that the installation further includes radially aligning locking ring 196 so that cam shoulders 198 are free from interference with existing feature 254 and openings 258 of strike plate 124 and gasket 184-2 when present are clocked or aligned with existing feature 256 of the connector 105 during the axial movement.

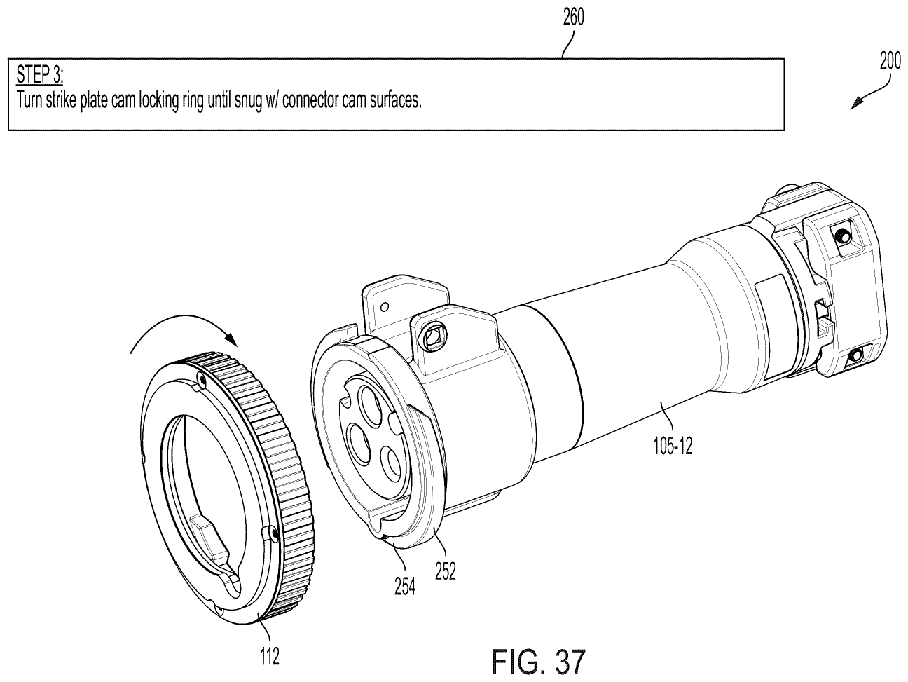

In a next step 260 of FIG. 37, line side components 112 are rotated so that cam shoulders 198 engage with 254 and draw the line side components into connector 105.

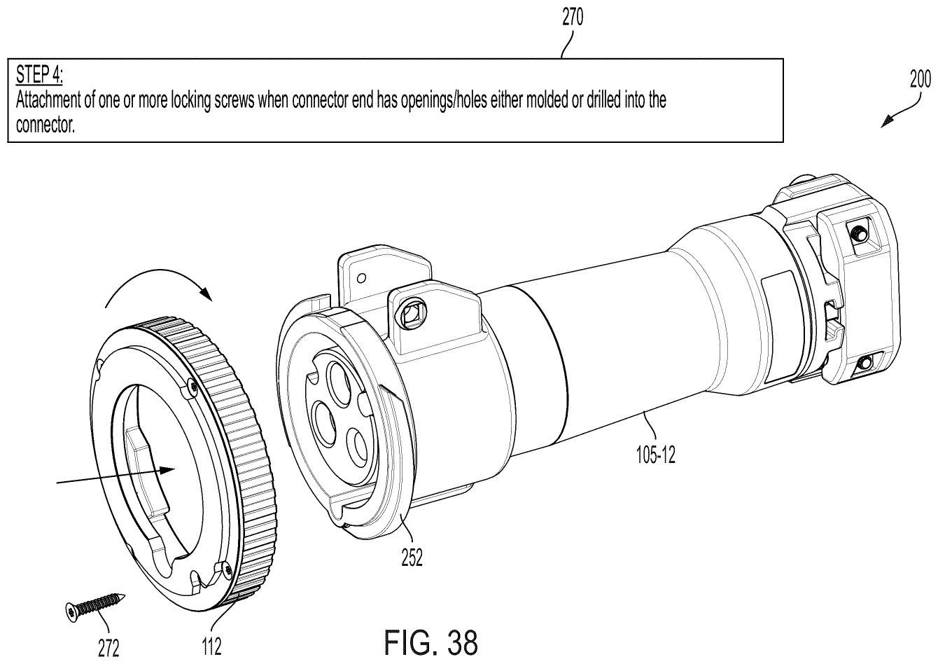

In some embodiments, method 200 includes a final step 270 of FIG. 38, where line side components 112 are further secured to connector 105 using screws 272 in holes formed by field modifying free end 252 of connector 105 (e.g., drilling or self-taping screws).

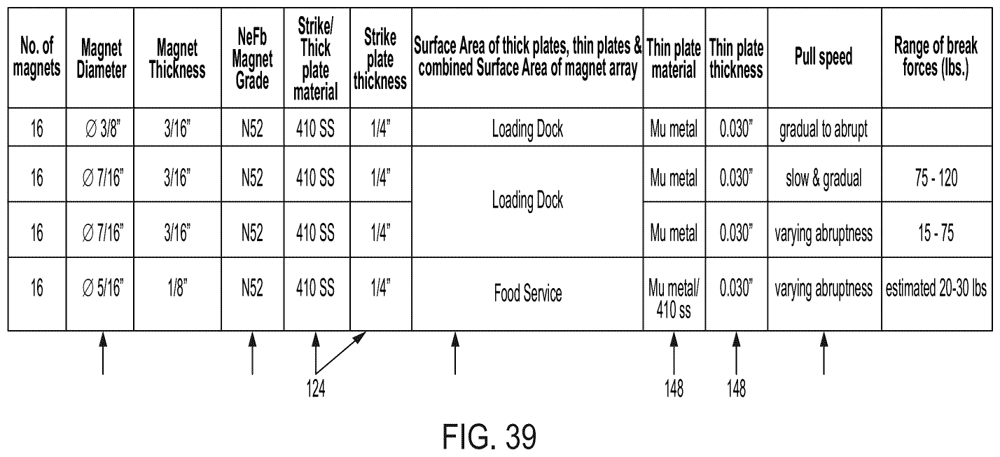

FIG. 39 illustrates geometries, materials, and resultant pull forces according to the present disclosure. Here, it can be seen that connector 105 as retrofitted with assembly 110 for use in food service applications provides lower pull forces as compared connector 10 for use in loading dock applications.

The pull force as used herein refers to a static pull force. Without wishing to be bound by any particular theory, the static pull force is the force necessary for a static or substantially static load in a single direction overcomes the magnetic forces to cause the connector to breakaway or separate. It is recognized that dynamic loads and/or loads in multiple directions can result in breakaway below the static pull forces disclosed herein. Simply, the manner in which the load is applied to the connector affects the force necessary to separate or breakaway the connector. For example, acceleration of the load can create separation or breakaway below the static pull force. Thus, the static pull force as used herein provides relative measurement system to measure the impact that different variables (e.g., number of magnets, materials, thickness, etc.) have on the connector's ability to resist separation.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

PARTS LIST

| | |
|---|---|
| breakaway electrical connector 10 | lip seal 62 |
| line side 12 | inner radial surface 64 of line side 12 |
| load side 14 | gasket seal 66 |
| line conductor 16 | planar surfaces 68 of line side 12 and load |
| load conductor 18 | side 14 |
| compression fitting 20 | protrusions 70 |
| magnetic assembly 22 | O-ring seal 72 |
| strike plate 24 | outer radial surface 74 of load side 14 |
| ground contact 26 | O-ring seal 76 |
| neutral contact 28 | protrusion 78 |
| hot contacts 30, 32 | additional radial sealing surface 80 |
| alignment feature and/or auxiliary contact 34 | bumper 82 |
| alignment protrusion 34-1 | breakaway retrofit assembly 110 |
| alignment protrusion 34-2 | prior art electrical connector 105 |
| distance 36 | line side 105-12 |
| recess 38 | load side 105-14 |
| shroud 40 | line side components 112 |
| first or base plate 42 | load side components 114 |
| magnet holder 44 | strike plate 124 |
| magnets 46 | first or base plate 142 |
| second or top plate 48 | magnet holder 144 |
| mechanical fasteners 50 | magnets 146 |
| central opening 52 | second or top plate 148 |
| fastener opening 54 | retaining ring 150 |
| discrete magnet locations 56 | bumper 182 |
| second alignment feature 58 | external extension 182-1 |
| corresponding second alignment feature 58b | internal extension 182-2 |
| test plate 60 | radial seal 182-3 |
| radial seal 182-4 | |
| first friction gasket 184-1 | |
| ring sections 150-1, 150-2 | |
| ring end 186 | |
| living hinge 188 | |
| free ends 190 | |
| fasteners 192 | |
| interlocking features 194 | |
| locking ring 196 | |
| second friction gasket 184-2 | |
| cam shoulders 198 | |
| method 200 | |
| first step 210 | |
| plug locking ring 212 | |
| ring slot 214 | |
| existing feature 216 | |
| second step 220 | |
| connector free end 222 | |
| connector feature 224 | |
| openings 226 | |
| third step 230 | |
| step 240 | |
| hinge pin 242 | |
| hinged cover 244 | |
| step 250 | |
| connector free end 252 | |
| existing features 254, 256 | |
| opening 258 | |
| step 260 | |
| step 270 | |
| screws 272 | |

What is claimed is:

1. A breakaway electrical connector, comprising:
a first side that is connectable to a first conductor, the first side having a magnetic assembly and a first plurality of contacts; and
a second side that is connectable to a second conductor, the second side having a strike plate and a second plurality of contacts,
wherein the magnetic assembly provides a magnetic connection force with respect to the strike plate to maintain the first and second sides in a connected state with the first and second plurality of contacts electrically coupled to one another.

2. The breakaway electrical connector of claim 1, further comprising a seal that seals the first and second sides when in the connected state, the seal being positioned radially outside of the magnetic assembly and radially outside of the first and second plurality of contacts.

3. The breakaway electrical connector of claim 1, wherein the first side is a line side and the second side is a load side.

4. The breakaway electrical connector of claim 3, wherein the line side further comprises a shroud extending around the first plurality of contacts between the first plurality of contacts and the magnetic assembly, and wherein the load side further comprises a recess defined around the second plurality of contacts between the second plurality of contacts and the magnetic assembly, the recess being configured to receive the shroud when the first and second plurality of contacts are in the connected state.

5. The breakaway electrical connector of claim 4, further comprising a seal that seals the line and load sides when in the connected state, the seal being positioned radially outside of the magnetic assembly, the shroud, the recess, and the first and second plurality of contacts.

6. The breakaway electrical connector of claim 1, wherein the first side is a load side and the second side is a line side.

7. The breakaway electrical connector of claim 6, wherein the line side further comprises a shroud extending around the first plurality of contacts between the first plurality of contacts and the magnetic assembly, and wherein the load side further comprises a recess defined around the second plurality of contacts between the second plurality of contacts and the magnetic assembly, the recess being configured to receive the shroud when the first and second plurality of contacts are in the connected state.

8. The breakaway electrical connector of claim 7, further comprising a seal that seals the line and load sides when in the connected state, the seal being positioned radially outside of the magnetic assembly, the shroud, the recess, and the first and second plurality of contacts.

9. The breakaway electrical connector of claim 7, wherein the shroud and the recess comprise electrically insulating material.

10. The breakaway electrical connector of claim 7, wherein the line and load sides are configured to that the recess receives the shroud prior to the first plurality of contacts being within an electrically communicating distance of the second plurality of contacts during movement between the connected state and a disconnected state.

11. The breakaway electrical connector of claim 1, wherein the magnetic connection force is lower than a pull-apart strength of the line side and the load side.

12. The breakaway electrical connector of claim 1, wherein the magnetic connection force is between 45 and 95 pounds.

13. The breakaway electrical connector of claim 1, wherein the magnetic connection force is between 60 and 85 pounds.

14. The breakaway electrical connector of claim 1, wherein the magnetic assembly comprises a first plate, a magnet holder, a plurality of magnets in the magnet holder, and a second plate, the magnetic assembly being positioned in the first side so that the second plate contacts the strike plate in the connected state.

15. The breakaway electrical connector of claim 14, wherein the first plate and the strike plate are identical.

16. The breakaway electrical connector of claim 14, wherein the first plate, the strike plate, and the second plate are ferrous material.

17. The breakaway electrical connector of claim 14, wherein the strike plate and the first plate are made of 410 and the second plate is made of 430 stainless steel.

18. The breakaway electrical connector of claim 14, wherein the magnet holder is made of a magnetic or non-magnetic material.

19. The breakaway electrical connector of claim 14, further comprising a plurality of mechanical fasteners passing through the magnetic assembly and securing the magnetic assembly to the first side.

20. The breakaway electrical connector of claim 14, wherein the first plate has a first thickness dimensioned, with respect to a magnet flux of the plurality of magnets, so that the first plate is fully saturated by the magnetic flux, and the second plate has a second thickness dimensioned, with respect to the magnet flux, so that the second plate is not fully saturated by the magnetic flux.

21. The breakaway electrical connector of claim 14, wherein the plurality of magnets each have a southern pole and a northern pole, the magnetic assembly being configured with an even number of magnets arranged with adjacent magnets having the northern and southern poles in opposite directions.

22. The breakaway electrical connector of claim 14, wherein the first plate, the magnet holder, and the second plate further comprise an alignment feature thereon that corresponds to another alignment feature in the first side.

23. The breakaway electrical connector of claim 14, wherein the magnetic assembly has a central opening configured so that the first plurality of contacts are within the central opening.

24. The breakaway electrical connector of claim 23, wherein the second plate has an inner dimension and an outer dimension that completely covers a top surface of the magnetic holder.

25. The breakaway electrical connector of claim 23, wherein the second plate has an inner dimension and an outer dimension that completely covers a top surface of the plurality of magnets.

26. The breakaway electrical connector of claim 1, wherein the first or second side is configured and adapted for use with a food service device.

27. The breakaway electrical connector of claim 1, further comprising a first bumper secured to the first side and a first bumper secured to the second side.

28. The breakaway electrical connector of claim 27, wherein the first and second bumpers are configured as a waterproof seal.

29. The breakaway electrical connector of claim 27, wherein the first bumper has an external extension and the second bumper on the second side has an internal extension, the internal extension being received in the external extension to form a tortious path defined by at least one radial seal and/or at least one face seal.

30. A retrofit kit for converting an electrical connector to a breakaway connector, comprising:
a load side component assembly having a base plate, a magnet holder with a plurality of magnets, a top plate, and a retaining ring, the retaining ring being configured to secure the load side component assembly to a load side of the electrical connector; and
a line side component assembly having a strike plate and a locking ring, the locking ring being configured to secure the line side component assembly to a line side of the electrical connector.

31. The retrofit kit of claim 30, wherein the load side component assembly further comprises a first friction gasket between the base plate and the magnet holder.

32. The retrofit kit of claim 30, wherein the retaining ring comprises sections secured to one another at one end by a living hinge and securable to one another at free ends by one or more fasteners.
